(19) United States
(12) Patent Application Publication
(10) Pub. No.: US 2004/0095474 A1
(43) Pub. Date: May 20, 2004

(54) Imaging apparatus using imaging template

(76) Inventor: Isao Matsufune, Kanagawa (JP)

Correspondence Address: FROMMER LAWRENCE & HAUG LLP, 745 FIFTH AVENUE, NEW YORK, NY, 10151, US

(21) Appl. No.: 10/704,425

(22) Filed: Nov. 7, 2003

(30) Foreign Application Priority Data
Nov. 11, 2002 (JP) P2002-326996

(51) Int. Cl. H04N 5/225

(52) U.S. Cl. 348/220.1

(57) ABSTRACT

An imaging apparatus selects a particular scene to be shot from an imaging template in which the arrangement of scenes of content is indicated by image materials selected from among moving image materials and/or still image materials recorded on a recording medium. When the shooting is performed in this state, an image material generated by the shooting is managed in association with the selected scene. The content is completed by replacing the image material constituting each of the scenes in the imaging template with another image material, such as the image material generated by the shooting.

### BACKGROUND OF THE INVENTION

1. Field of the Invention

The present invention relates to imaging apparatuses for producing video content.

2. Description of the Related Art

Imaging apparatuses, such as portable video cameras, have been widely used for business and general domestic purposes.

The wide use of video equipment including video cameras and players has increased the chances for general users to see video content and to produce video content for fun. Also, companies, shops, local governments, educational institutions including schools, and the like have used video content more often in doing their services.

For example, a resort service provider shoots a tourist video and sells this video to tourists. Also, video content including a commercial or promotional video for a product, a video for introducing a local area, and an educational video is used in making various presentations.

In the present specification, “content” or “video content” refers to one completed video title, such as the above-described video for sales, commercial, and promotion, a movie, a commercial film, or a television program.

A technique for creating video content is disclosed in Japanese Unexamined Patent Application Publication No. 2000-48543.

It is difficult for anyone other than a specialist, such as a video content producer, to produce content, even a simple one lasting a short time of a few minutes.

FIG. 34 shows a process of producing content.

As shown in FIG. 34, content production largely involves three steps: content project preparation, scene shooting, and editing.

In the content project preparation step, a project proposal for content to be produced is designed. Specifically, the arrangement of scenes in one piece of content, shooting locations, schedule (time and date), the details of each scene, a process of shooting each scene, and the like are planned.

In particular, the arrangement of scenes is determined by planning a sequence of the scenes, scene time, the details of images to be shot, the method of shooting each scene, and the like. Such scene arrangement planning requires the consideration of the rendition of completed content, which requires high skills and visual senses.

The details of each scene must be specified by drafting a script with drawings.

When the project including the scene arrangement and the script with drawings is completed, the scene shooting step is performed. Each scene is shot on location in accordance with the details and the process specified in the project proposal.

After the necessary scenes have been shot, the video shots are edited. Specifically, the video images or the shots of the scenes are cut and pasted, and special effects including a wipe and a fade, background music (BGM), and narration are inserted. The editing work involves high skills, knowledge of editing equipment, and visual senses.

After the necessary editing is done, one piece of video content is completed.

With the content production process, video content at a level satisfactory for the above-described business purposes is created. Such content production is very difficult for anyone other than a content production specialist and requires a long period of time.

For example, this content production is not easily applicable to simple content production by resort service providers, local governments, shops, companies, and the like.

For example, when a resort service provider plans to shoot a tourist video and to quickly produce and sell this video content, it is practically impossible, from the viewpoint of time and cost, for the resort service provider to follow the above-described production steps.

It is desirable not to ask a video content production specialist to produce the video content, but to produce the video content by the staff of the resort service provider or the like in a simple manner.

There has been a demand for enabling anyone other than an expert to quickly produce video content in a simple manner at some satisfactory level for business use by using simple equipment, such as a portable video camera, without using a large production system.

### SUMMARY OF THE INVENTION

Accordingly, it is an object of the present invention to enable anyone other than an expert having special knowledge and skills to produce video content in a simple and efficient manner by using simple equipment and materials.

According to an aspect of the present invention, an imaging apparatus is provided including an imaging unit for capturing an image of an object being shot and generating a video image signal; a recording and playing unit for recording various information including the video image signal on a recording medium and playing the information recorded on the recording medium; a shooting scene selection control unit for performing a process of selecting a particular scene to be shot from an imaging template in which the arrangement of scenes of content is indicated by image materials selected from among moving image materials and/or still image materials recorded on the recording medium; a video image managing unit for recording, when the shooting is performed by the imaging unit while the particular scene is selected by the process by the shooting scene selection control unit, the video image signal generated by the shooting as an image material on the recording medium using the recording and playing unit and for managing the image material recorded on the recording medium in association with the selected scene in the imaging template; and a replacement control unit for replacing the image material constituting each of the scenes in the imaging template with another image material.

According to another aspect of the present invention, a content producing method is provided including a first step of selecting a particular scene to be shot from an imaging template in which the arrangement of scenes of content is indicated by image materials selected from among moving image materials and/or still image materials recorded on a recording medium; a second step of recording, when the shooting is performed while the particular scene is selected in the first step, a video image signal generated by the shooting as an image material on the recording medium and managing the image material recorded on the recording medium in association with the selected scene in the imaging template; and a third step of replacing the image material constituting each of the scenes in the imaging template with another image material.

According to another aspect of the present invention, a program for causing a computer to perform a content producing method is provided. The content producing method includes a first step of selecting a particular scene to be shot from an imaging template in which the arrangement of scenes of content is indicated by image materials selected from among moving image materials and/or still image materials recorded on a recording medium; a second step of recording, when the shooting is performed while the particular scene is selected in the first step, a video image signal generated by the shooting as an image material on the recording medium and managing the recorded image material in association with the selected scene in the imaging template; and a third step of replacing the image material constituting each of the scenes in the imaging template with another image material.

According to another aspect of the present invention, an imaging template creating method is provided including a setting step of setting an image material selected from among moving image materials and/or still image materials recorded on a recording medium to each of scenes of content to be produced; and a management step of managing scene setup information as an imaging template, the scene setup information including one or more image materials set to each of the scenes one after another by performing the setting step one or more times.

According to another aspect of the present invention, a program for causing a computer to perform an imaging template creating method is provided. The imaging template creating method includes a setting step of setting an image material selected from among moving image materials and/or still image materials recorded on a recording medium to each of scenes of content to be produced; and a management step of managing scene setup information as an imaging template, the scene setup information including one or more image materials set to each of the scenes one after another by performing the setting step one or more times.

According to another aspect of the present invention, an imaging apparatus is provided including an imaging unit for capturing an image of an object being shot and generating a video image signal; a recording and playing unit for recording various information including the video image signal on a recording medium and playing the information recorded on the recording medium; a scene selection control unit for setting an image material selected from among moving image materials and/or still image materials recorded on the recording medium to each of scenes of content to be produced; and a template setup unit for managing scene setup information as an imaging template, the scene setup information including one or more image materials set to each of the scenes one after another by the scene selection control unit.

### BRIEF DESCRIPTION OF THE DRAWINGS

FIG. 1 is an illustration of an imaging apparatus according to an embodiment of the present invention;

FIG. 2 is a block diagram of the imaging apparatus of the embodiment;

FIG. 3 is an illustration of operation modes of the imaging apparatus of the embodiment;

FIG. 4 is an illustration of content to be produced in the embodiment;

FIGS. 5A and 5B are illustrations of the recording state of a disk in the imaging apparatus of the embodiment;

FIG. 6 is an illustration of displayed index images in the embodiment;

FIG. 7 is an illustration of a still image of a shooting instruction in the embodiment;

FIG. 8 is another illustration of a still image of a shooting instruction in the embodiment;

FIG. 9 is a flowchart showing a process in a template creating mode in the embodiment;

FIG. 10 is an illustration of a template creating mode screen in the embodiment;

FIG. 11 is an illustration of a state in which a clip is selected on the template creating mode screen in the embodiment;

FIG. 12 is an illustration of copying the selected clip to a template on the template creating mode screen in the embodiment;

FIG. 13 is another illustration of copying the selected clip to the template on the template creating mode screen in the embodiment;

FIG. 14 is an illustration of a state after the scene has been selected on the template creating mode screen in the embodiment;

FIG. 15 is an illustration of locking on the template creating mode screen in the embodiment;

FIG. 16 is an illustration of a template created in the template creating mode in the embodiment;

FIG. 17 includes illustrations of a template file in the embodiment;

FIG. 18 is a flowchart showing a process in a shooting mode in the embodiment;

FIG. 19 is an illustration of a scene selecting screen in the shooting mode in the embodiment;

FIG. 20 is an illustration of a preview displayed in the shooting mode in the embodiment;

FIG. 21 is an illustration of the screen at the time of shooting in the embodiment;

FIG. 22 includes illustrations of the template file after the shooting in the embodiment;

FIG. 23 is an illustration of a clip replacement enquiry screen in the shooting mode in the embodiment;

FIG. 24 is an illustration of the screen upon replacement of a clip in the embodiment;

FIG. 25 includes illustrations of the template file after the clip has been replaced in the embodiment;

FIG. 26 is an illustration of the screen in which no clip is replaced in the embodiment;

FIG. 27 includes illustrations of the template file when no clip is replaced and when the shooting is terminated in the embodiment;

FIG. 28 includes illustrations of the template file when the clips are replaced and when the shooting is terminated in the embodiment;

FIG. 29 is a flowchart showing a process in a scene re-selecting mode in the embodiment;

FIG. 30 is an illustration of a scene selecting screen in the scene re-selecting mode in the embodiment;

FIG. 31 is an illustration of a take selecting screen in the scene re-selecting mode in the embodiment;

FIG. 32 is an illustration of a state in which a selected take is confirmed in the scene re-selecting mode in the embodiment;

FIG. 33 includes illustrations of the template file after the scene has been re-selected in the embodiment; and

FIG. 34 is an illustration of a known content production process.

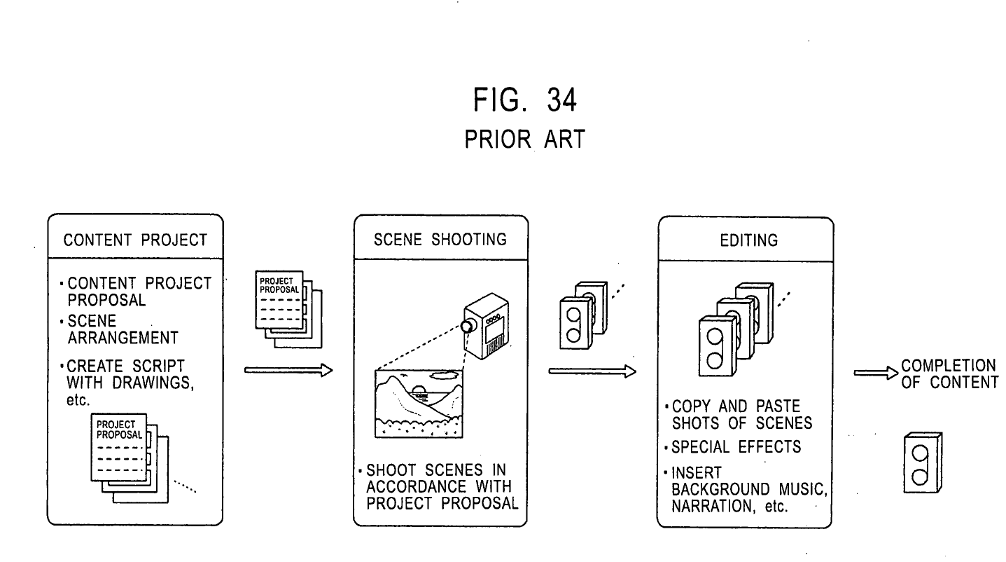

### DESCRIPTION OF THE PREFERRED EMBODIMENTS

Embodiments of the present invention will now be described. In the embodiments, the mechanism and operation of an imaging apparatus (video camera) for recording video on a disk recording medium, the imaging apparatus being enabled to create an imaging template and to produce video content using such an imaging template (hereinafter may simply be referred to as a template), will now be described.

1. Configuration of Video Camera

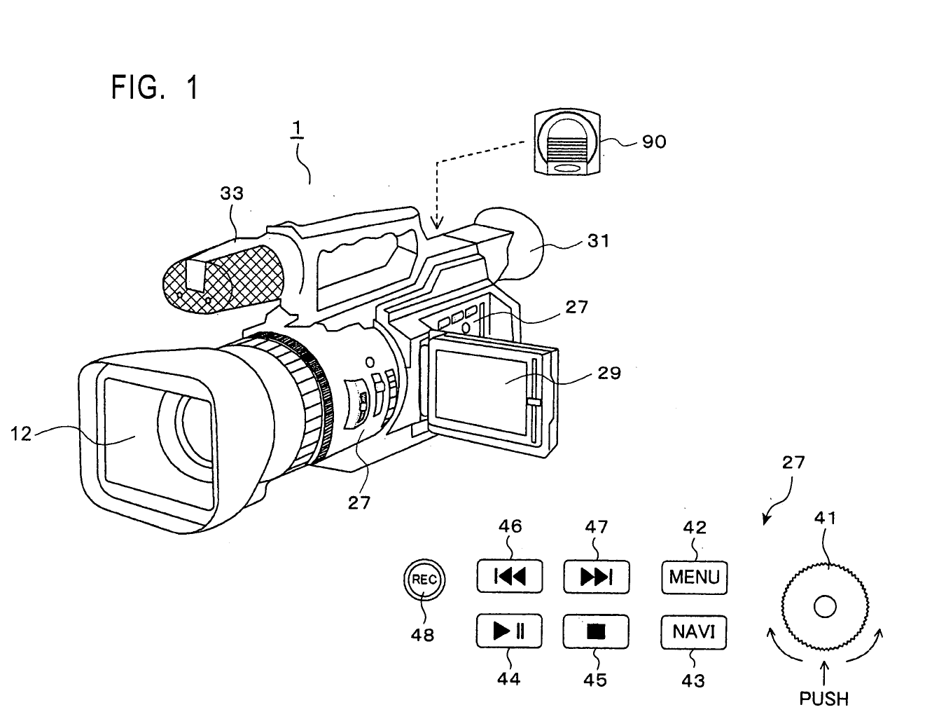

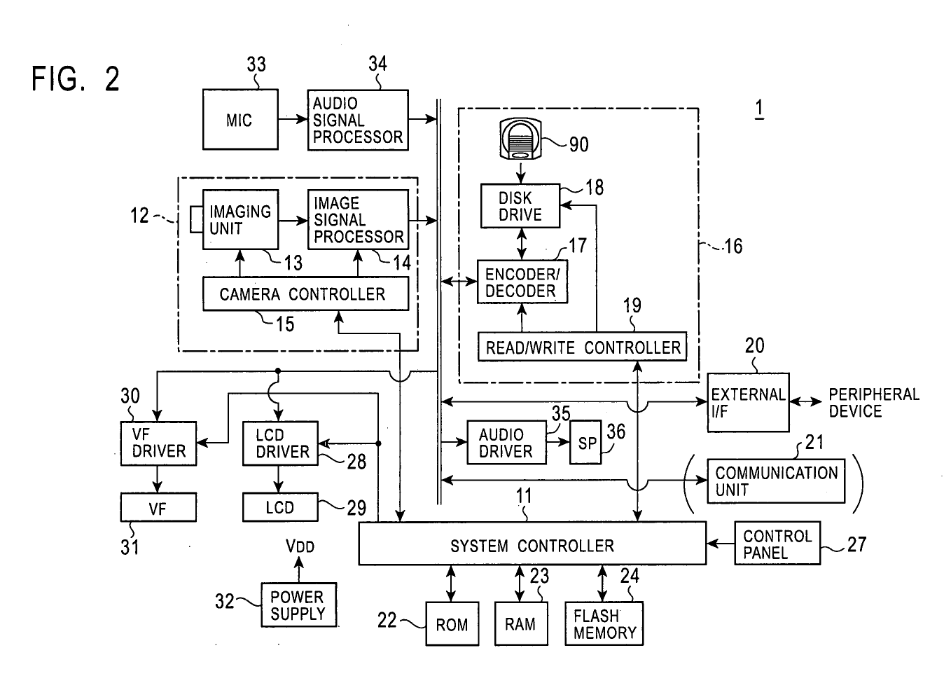

The configuration of a video camera according to an embodiment of the present invention will be described with reference to FIGS. 1 and 2.

FIG. 1 shows an example of the appearance of a video camera 1.

A user of the video camera 1, which may be referred to as a video shooter, shoots images while looking into a viewfinder 31 or looking at a liquid crystal display (LCD) 29.

Referring to FIG. 1, the video camera 1 includes a camera unit 12 for shooting images, a microphone 33 for collecting sounds at the time of shooting, and a control panel 27 for performing various operations.

Although not shown in FIG. 1, for example, a disk drive on which a disk 90 is to be placed is disposed on the side opposite to the side on which the LCD 29 is disposed.

The control panel 27 includes control buttons, such as keys and a jog dial, for performing various operations, such as shooting and playing images by the video camera 1, changing the operation mode, adding effects, and changing the display state.

FIG. 1 shows a case in which control buttons for use in navigated shooting using a template are illustrated.

For example, a jog dial 41 can be rotated and pressed. The jog dial 41 is used to move a cursor (selection), enter information (confirmation), and the like.

Operation keys provided include a menu key 42, a navigation key 43, a play/pause key 44, a stop key 45, a rewind key 46, a fast forward key 47, and a record key (shoot key) 48. These keys are for performing predetermined operations.

FIG. 2 shows the internal configuration of the video camera 1.

A system controller 11 includes a microcomputer and controls the overall video camera 1. In other words, the system controller 11 controls the operation of components described below.

The camera unit 12 is to capture video images and includes an imaging unit 13, an image signal processor 14, and a camera controller 15.

The imaging unit 13 includes a lens system including an imaging lens, a diaphragm, and the like; a drive system for causing the lens system to perform auto-focusing and zooming; a CCD (Charge Coupled Device) that detects imaging light obtained by the lens system and generates an image signal by performing photoelectric conversion; and the like.

The image signal processor 14 includes a sample-hold/AGC (Automatic Gain Control) circuit that adjusts the gain and shapes the waveform of a signal generated by the CCD of the imaging unit 13 and a video A/D converter. The image signal processor 14 generates digital video data from the captured image data.

On the basis of an instruction from the system controller 11, the camera controller 15 controls the operation of the imaging unit 13 and the image signal processor 14. For example, the camera controller 15 controls the imaging unit 13 (motor control) to perform auto-focusing, auto-exposure control, diaphragm control, and zooming.

The camera controller 15 includes a timing generator. Using a timing signal generated by the timing generator, the camera controller 15 controls the signal processing operation of the CCD and the sample-hold/AGC circuit and the video A/D converter of the image signal processor 14.

With this arrangement, the camera unit 12 generates video image data.

An audio signal obtained by the microphone 33 is A/D-converted by an audio signal processor 34 to generate audio data in synchronization with the video image data.

A read/write unit 16 writes the video image data generated by the camera unit 12 (and the audio data generated by the microphone 33) onto the disk 90, which is a recording medium, and reads the data from the recording medium.

The read/write unit 16 includes an encoder/decoder 17, a disk drive 18, and a read/write controller 19.

At the time of shooting, the encoder/decoder 17 compresses the video image data (moving image data) generated by the camera unit 12 into MPEG (Moving Picture Experts Group) format or the like or into a recording format of the disk 90. Similarly, the encoder/decoder 17 compresses the audio data and converts the format of the audio data. Alternatively, the video image data and the audio data may be recorded on the disk 90 without being compressed.

In this embodiment, the video camera 1 has an additional function of capturing a still image. Specifically, one frame of the video image data captured by the camera unit 12 may be loaded as still image data and recorded by the read/write unit 16 on the disk 90. In this case, the encoder/decoder 17 compresses one frame of the video image data (still image data) into JPEG (Joint Photographic Experts Group) format or the like or into the recording format of the disk 90. Alternatively, the still image data may be recorded on the disk 90 without being compressed.

The video image data serving as the moving or still image (and the audio data) processed by the encoder/decoder 17 are supplied to serve as an image material or the like (described below) to the disk drive 18 and recorded on the placed disk 90.

When reading the data recorded on the disk 90, the video data (and the audio data) read by the disk drive 18 are decoded by the encoder/decoder 17.

On the basis of an instruction from the system controller 11, the read/write controller 19 controls the processing by the encoder/decoder 17, reading/writing by the disk drive 18, and data input/output.

The disk drive 18 is controlled to read/write management information, such as management information in FAT (file allocation table) format, and to edit data recorded on the disk 90 in response to the updating of the management information.

The video image data generated by the camera unit 12 at the time of shooting and the video data read from the disk 90 can be displayed on the viewfinder 31 and the LCD 29.

At the time of shooting or in a shooting standby mode, when the camera unit 12 outputs video image data, the video image data is supplied to both or either of a viewfinder driver 30 and an LCD driver 28.

In response to an instruction from the system controller 11, the viewfinder driver 30 and the LCD driver 28 cause the viewfinder 31 and the LCD 29, respectively, to display a video image based on the video image data. Also, the viewfinder driver 30 and the LCD driver 28 superimpose a character image in response to an instruction from the system controller 11.

At the time of reading the video data from the disk 90, the video data read and output by the disk drive 18 and decoded by the encoder/decoder 17 is supplied to both or either of the viewfinder driver 30 and the LCD driver 28. In response to an instruction from the system controller 11, the viewfinder driver 30 and the LCD driver 28 cause the viewfinder 31 and the LCD 29, respectively, to display a video image based on the supplied video data and a character image superimposed on the video image and to display a plurality of image materials read from the disk 90.

Looking at the viewfinder 31 and/or the LCD 29, a user of the video camera 1 monitors an object to be shot in the shooting standby mode or at the time of shooting and checks and edits the details of a video image recorded on the disk 90. The video data (image materials) recorded on the disk 90 includes video data (moving/still images) captured and recorded by the video camera 1, video data recorded by another device onto the disk 90, and video data transferred from another device and recorded on the disk 90.

The audio data read from the disk 90 is D/A-converted by an audio driver 35, subjected to signal processing such as filtering and amplification, and output from a speaker 36.

An external interface 20 inputs and outputs video data and the like to and from external devices including an audio/visual device, an information device, a storage device, and the like.

A communication unit 21 performs wired and wireless network communication. For example, the communication unit 21 includes a modem, an Ethernet interface, a cellular phone interface, and the like.

These components are not directly related to the shooting operation based on a template recorded on the disk 90, which will be described later. These components are used to transfer a template or an image material created by an external device to the video camera 1 and to record the transferred template or image material on the disk 90.

A ROM (Read Only Memory) 22, a RAM (Random Access Memory) 23, and a flash memory 24 are used as storage areas and arithmetic areas for data and programs required by the system controller 11.

For example, the ROM 22 stores a processing program for the system controller 11, fixed data, and the like. The RAM 23 is used as a storage or work area for temporarily storing information. The flash memory 24 stores various control coefficients and the like.

The control panel 27 includes, as described with reference to FIG. 1, various control buttons (power ON/OFF, shoot, play, zoom, various modes, and edit buttons) for the user to perform operations to the video camera 1.

In response to detection of a user operation using the control button(s), the system controller 11 controls the components to perform necessary operations.

In a power supply 32, a DC/DC converter converts DC power obtained from a built-in battery or DC power generated from commercial AC power via a power adapter into power supply voltage at a predetermined level and supplies the power supply voltage to the circuits. Turning power ON and OFF by the power supply 32 is controlled by the system controller 11 in accordance with the power ON/OFF operation from the control panel 27.

Although the video camera 1 arranged as described above has the LCD 29, the video camera 1 need not have the LCD 29.

The details of images displayed on the LCD 29 at the time of template creation, scene shooting, or the like are described later. Alternatively, an external monitor device may be connected, and the external monitor device may display images as in the LCD 29.

2. Outline of Navigated Shooting

The video camera 1 of the embodiment is capable of performing normal shooting and navigated shooting based on a template (template-navigated shooting). By shooting images based on a template, content prescribed by the template is produced easily and quickly.

In a template, scenes constituting content are set using image materials. A template is created prior to shooting. The video camera 1 of the embodiment can create a template.

A template serves as project data for content to be produced. Template-navigated shooting completes the project data into final complete content (or a so-called perfect packaged program).

The video camera 1 of the embodiment carries out a series of operations from preparing a content project to completing a perfect packaged program in a very simple manner.

To simplify the description, an “image material”, which may also be referred to as a “clip”, refers to one unit of moving or still image data recorded on the disk 90.

A “scene” serves as one unit of data constituting content. One piece of content includes one or plural scenes.

A template is formed by allocating one image material (clip) to each scene.

A schematic description of the operation of template-navigated shooting will be given.

From a template in which the arrangement of scenes is set by image materials, a scene to be shot is selected. While this scene is selected, a video image is shot. This video image is recorded as an image material. Such shooting is performed for necessary scenes. Content based on the template is produced by replacing an image material of each of the scenes in the template with the image material generated by the shooting. This content serves as the edited, completed content ready to be output.

The efficient shooting operation is achieved by giving a shooting instruction on the manner of shooting the subsequent scene to the video shooter or the user.

Functions of Video Camera

To create a template and perform template-navigated shooting, the video camera 1 of the embodiment has the following functions:

The video camera 1 complies with a non-linear recording medium, such as an optical disk, a hard disk, or a semiconductor memory; the optical disk 90 is used in the embodiment;

The video camera 1 can capture both moving and still images;

The video camera 1 can display a list of image materials, which are moving and still images recorded on the disk 90, using index images;

The recording device (disk 90) can record not only video and audio data, but also a template file indicating the arrangement of scenes required to complete video content;

The video camera 1 has a function of creating a template;

The video camera 1 has a function of displaying the outline of the next scene to be shot in accordance with the template and informing the video shooter of this outline;

The video camera 1 can shoot plural video images (plural takes) in each scene in the template and select the best take from among the plural takes; and

The video camera 1 inserts the captured image materials into the scenes in the template and plays the result as seamless video content.

Operation Modes

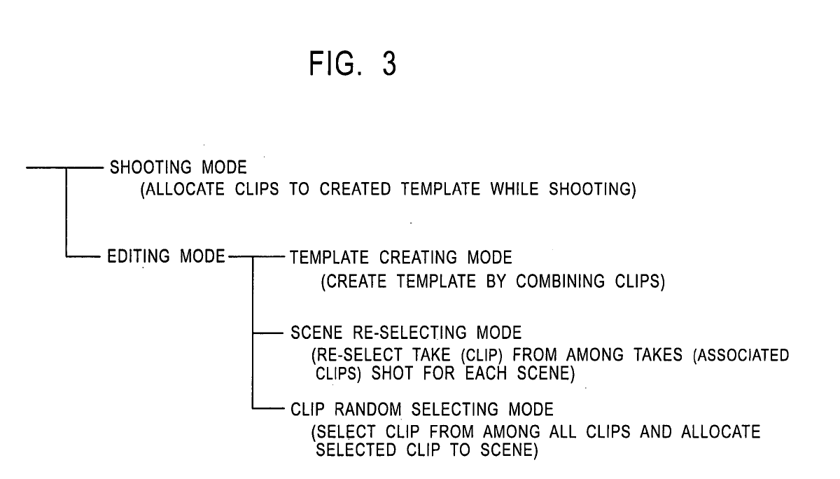

FIG. 3 shows examples of operation modes associated with the navigated shooting by the video camera 1 having the above-described functions.

The operation is largely divided into two modes: shooting mode and editing mode.

In the shooting mode, the video camera 1 performs the above-described navigated shooting. Specifically, the video camera 1 shoots images in accordance with a template and allocates the captured image materials (clips) to the template.

The editing mode is divided into a template creating mode, a scene re-selecting mode, and a clip random selecting mode.

In the template creating mode, the video camera 1 creates a template by arranging clips to serve as scenes. After the template is created, the video camera 1 can add scenes or change the scenes.

In the scene re-selecting mode, in each scene in the template, the video camera 1 can select a clip (captured clip) from among clips managed in association with the corresponding scene.

In the clip random selecting mode, the video camera 1 can select an arbitrary clip from among all clips recorded on the disk 90 in each scene in the template.

Recording Medium

A non-linear recording medium, such as a disk or a semiconductor memory, has a feature of random accessibility.

The video camera 1 for recording video or audio on such a non-linear recording medium employs this feature to freely play captured video images in any sequence, irrespective of the sequence in which the video images are actually captured.

The association between clips and scenes and the sequence of scenes are easily changed.

Displaying of Index Image

As described above, the video camera 1 has a function of displaying clips recorded on the disk 90 using index images.

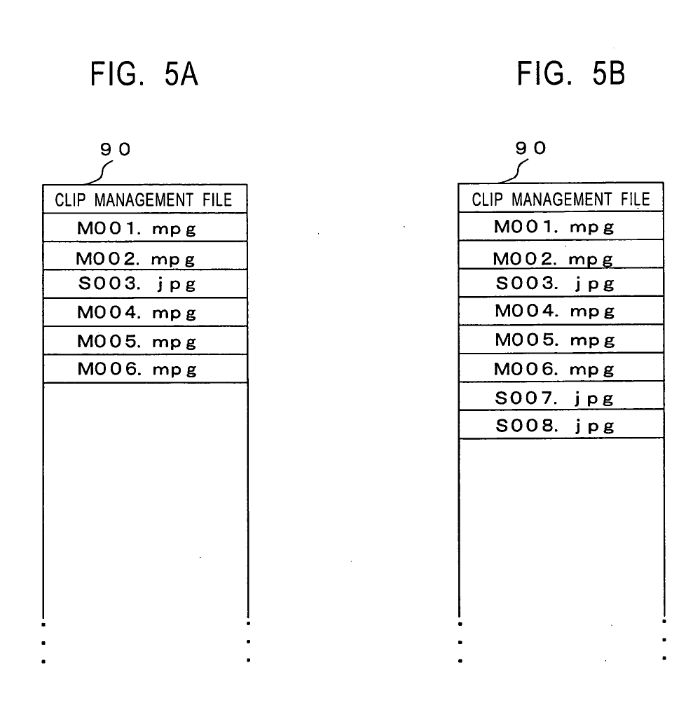

For example, the disk 90 has files recorded thereon as shown in FIG. 5A. The files named M001.mpg, M002.mpg, M004.mpg, M005.mpg, and M006.mpg are clips or moving images compressed in MPEG format. The file named S003.jpg is a clip or a still image compressed in JPEG format.

In this case, the files are managed by a clip management file so that the files can be arbitrary played from the disk 90. For example, the address, size, and attributes of each file are described in the clip management file.

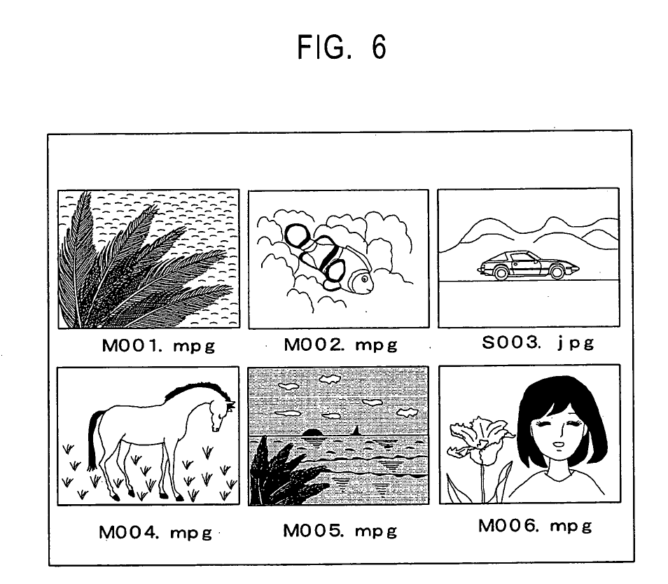

In such a state, under the control of the system controller 11 and the read/write controller 19, index images of the files are read (or generated) in response to a user operation and, as shown in FIG. 6, a list of the index images is displayed on the LCD 29 or the like.

If the list of index images cannot be displayed on one screen since the list contains too many files, the list can be displayed by scrolling or page feeding.

The index images are images representing the clips. In the case of a moving image clip, for example, an index image may be generated by reducing the size of one frame of the moving image. In this case, one frame serving as the index image may be the beginning frame of the moving image clip or an arbitrary frame extracted from the middle of the moving image clip, such as a frame at a particular time after the start of the recording. Alternatively, the user may select a frame to represent the clip.

In the case of a still image clip, an index image is generated by reducing the size of the still image data.

Image data serving as an index image may be automatically generated under the control of the read/write controller 19 at the time each clip is recorded and may be recorded as part of the file of each clip (or in a different file) on the disk 90. Alternatively, every time a list of clips is displayed, index image data may be generated.

When index images are displayed, one index image is selected and operated to play a moving or still image indicated by the selected index image (when the selected index image indicates a still image, the still image is displayed for a predetermined period of time). When a plurality of index images is selected and when the sequence of these index images is designated, the index images are played seamlessly.

Example of Content to be Produced

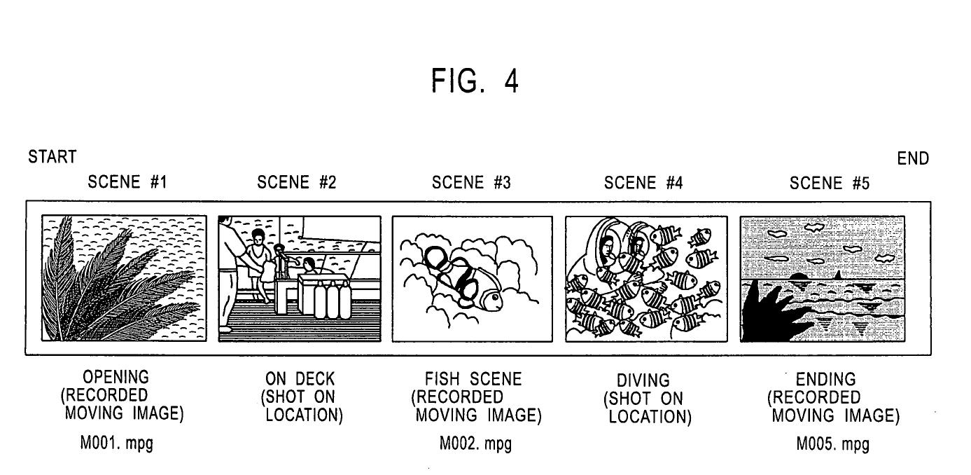

FIG. 4 shows an example of content to be produced.

In this example, video content is produced by shooting participants in try-out diving at a seaside tourist resort.

In this case, the final content or perfect packaged program has the following scene arrangement consisting of five scenes:

scene #1: opening title scene showing a digest of attractions in this resort area;

scene #2: scene showing the participants on a boat heading for a diving point;

scene #3: scene showing a fish swimming in the ocean;

scene #4: scene showing the participants actually diving; and

scene #5: ending scene showing the sunset.

In the actual content, the opening title scene #1, the fish scene #3, and the ending scene #5 remain unchanged even when the participants are different.

The actual shooting is necessary in scenes #2 and #4 where the participants are shot.

In a known content production process, after necessary images, that is, scenes #2 and #4 in this example, are shot, the editing must be performed to connect these captured scenes #2 and #4 with the images in scenes #1, #3, and #5.

In this example, the video camera 1 stores in advance a template with information on the scene arrangement and image materials (clips) of scenes #1, #3, and #5, which are used every time content is produced. Accordingly, after necessary scenes are shot, a perfect packaged program is generated automatically without the editing.

3. Template Creating Mode

In the example of content production described with reference to FIG. 4, the specific operation will now be described.

A template can be created by the video camera 1, and the created template can be recorded as a template file on the disk 90.

The video camera 1 creates a template easily by allocating a clip recorded on the disk 90 to each scene in the template.

When clips to be used as scenes of the actual complete content are already recorded on the disk 90, these clips may simply be allocated in the template. Clips serving as images for guiding the shooting of scenes to be actually shot are allocated to these scenes in the template.

Prior to the creation of the template, clips to be used as scenes of the content and clips serving as guides for scenes to be shot must be recorded on the disk 90.

A preparation work for the creation of the template will now be described.

Referring to FIG. 5A, various clips are recorded on the disk 90. To create content shown in FIG. 4, a clip or the file M001.mpg is used to serve as the opening scene #1. Similarly, clips or the files M002.mpg and M005.mpg are used to serve as scenes #3 and #5, respectively.

In this case, image materials for scenes #1, #3, and #5 are already on the disk 90.

In such a case where existing image materials are to be used, when no video clips are recorded on the disk 90, video clips must be recorded in advance on the disk 90, as shown in FIG. 5A. For example, video data is input to the video camera 1 via the external interface 20 and recorded on the disk 90 using the read/write unit 16. Alternatively, the disk 90 is placed on a disk drive of a personal computer or video equipment and video clips are recorded on the disk 90.

In the content of FIG. 4, scenes #2 and #4 are scenes where the participants are to be shot. Therefore, the shooting on location must be performed. Images in scenes #2 and #4 have not been recorded yet on the disk 90.

To allocate particular clips to scenes #2 and #4 in the template, clips corresponding to these scenes must be prepared. In particular, these clips display guide information about the shooting.

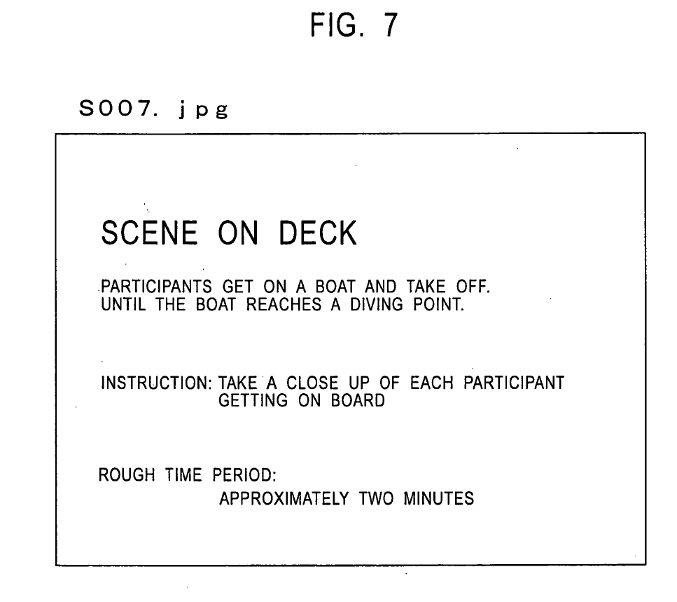

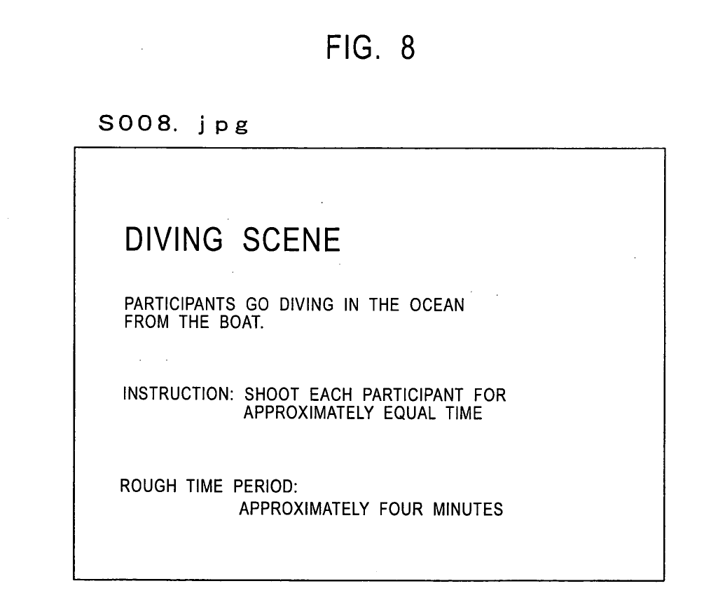

FIGS. 7 and 8 show specific examples (still images) of guide images for scenes #2 and #4. For example, scene #2 is a deck scene. As shown in FIG. 7, an image including the details of shooting, an instruction, and a rough time period is created.

To create such an image in a simple manner, for example, characters shown in FIG. 7 are written by hand on a white board or a piece of paper, and a still image of the white board or the paper on which the characters are handwritten is captured by the video camera 1. This image is recorded as a still image file named S007.jpg on the disk 90.

Similarly, scene #4 is a diving scene. As shown in FIG. 8, a still image of a piece of paper on which the details of shooting, an instruction, and a rough time period are written is obtained and recorded as a file named S008.jpg on the disk 90.

Accordingly, the disk 90 has files recorded thereon as shown in FIG. 5B. The disk 90 has sufficient clips for creating the template.

Alternatively, for example, images such as those shown in FIGS. 7 and 8 may be created on a personal computer or the like and recorded on the disk 90. The still image data created by the personal computer may be transferred to the external interface 20 of the video camera 1 and recorded using the read/write unit 16. Alternatively, the disk 90 may be placed on a disk drive of the personal computer, and the still image data may be recorded on the disk 90.

At the time the clips corresponding to all scenes in the template are recorded on the disk 90, it becomes ready to create the template.

At this time, the mode of the video camera 1 is changed to the template creating mode, and the template is created in the template creating mode. For example, the user presses the menu key 42 to display a menu screen. Using the jog dial 41, the user selects and confirms the template creating mode.

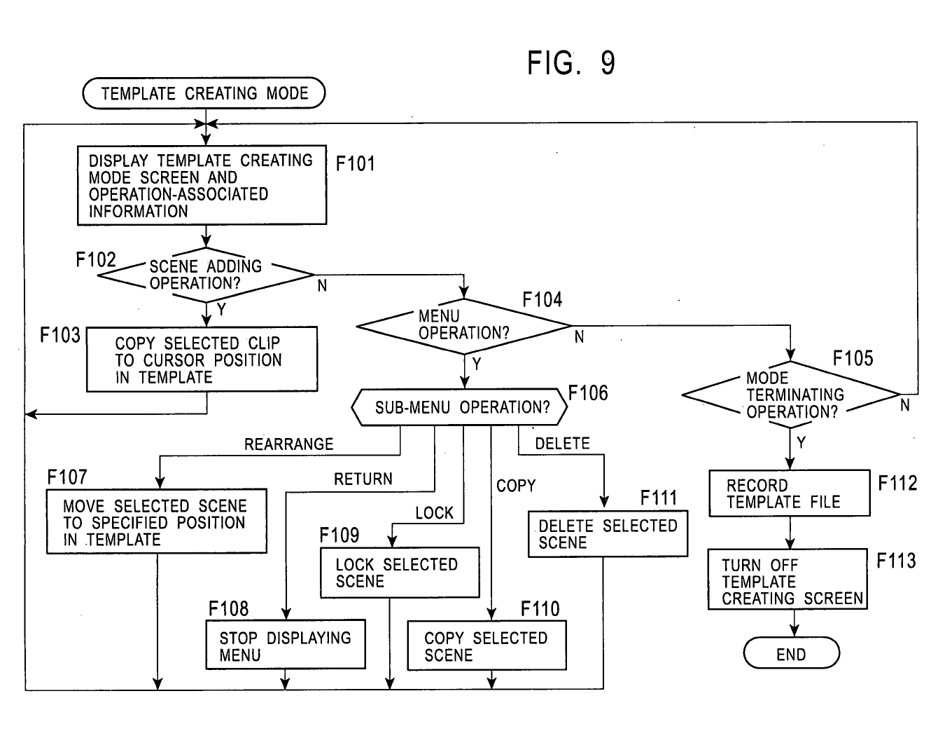

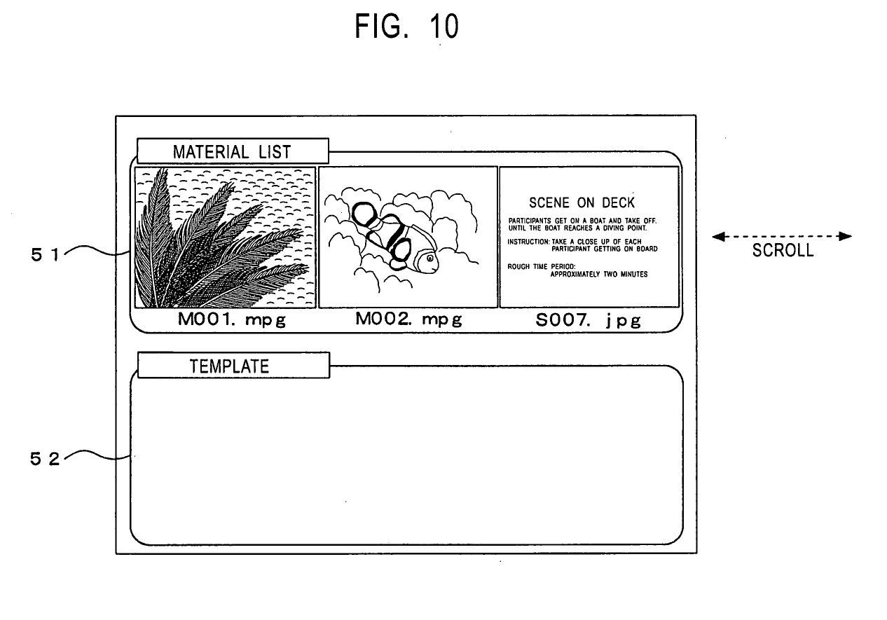

FIG. 9 shows a process performed by the system controller 11 in the template creating mode. With reference to FIGS. 10 to 15 showing examples of images displayed on the screen of the LCD 29 (or the viewfinder 31), the template creating operation will be described.

In the template creating mode, in step F101 of FIG. 9, the system controller 11 displays a template creating mode screen on the LCD 29. The system controller 11 also performs display control in response to a user operation on the template creating mode screen.

The template creating mode screen is, for example, shown in FIG. 10. In this case, a material list 51 is displayed in the upper portion of the screen, and a template window 52 is displayed in the lower portion of the screen.

The material list 51 is a list of index images of clips recorded on the disk 90 at this time. In FIG. 10, only three index images are displayed. The system controller 11 scrolls the images in the material list 51 from side to side in accordance with a user operation so that the user can view all clips in the material list 51.

In the template window 52 displayed in the lower portion of the screen, no image is displayed since the current state is the beginning state prior to the creation of the template.

On the template creating mode screen, the user performs an operation to select a clip from the material list 51.

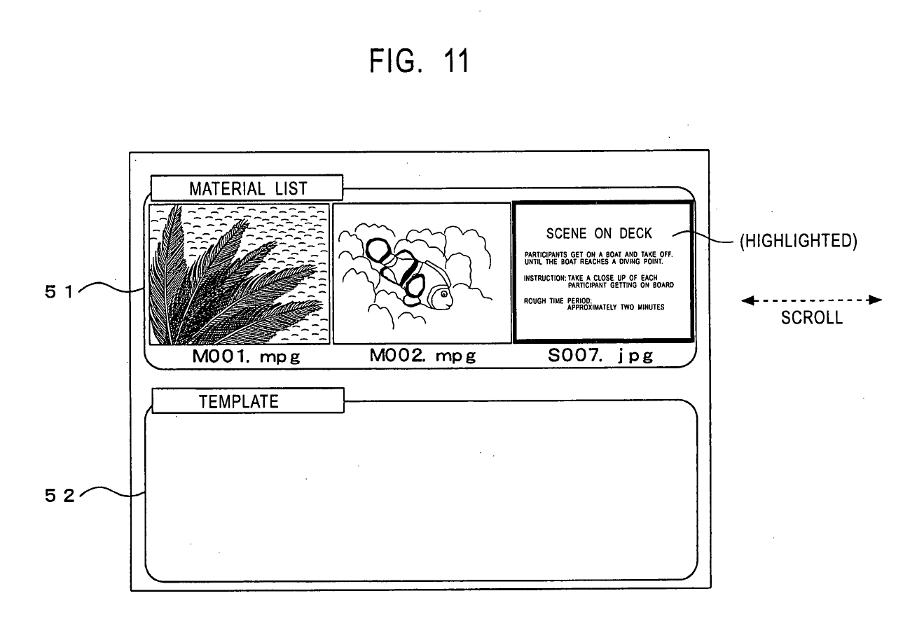

Specifically, the user rotates the jog dial 41 to highlight the individual clips in the material list 51 in the upper portion of the screen. While the material list 51 is being scrolled, the clips are highlighted one at a time. FIG. 11 shows a state in which the file S007.jpg is highlighted.

A clip highlighted or indicated by a cursor means that this clip is selected on the screen. In the drawings for the following description, an image portion highlighted or indicated by the cursor is shown using bold lines.

The user selects a clip to be allocated to scene #1 in the template.

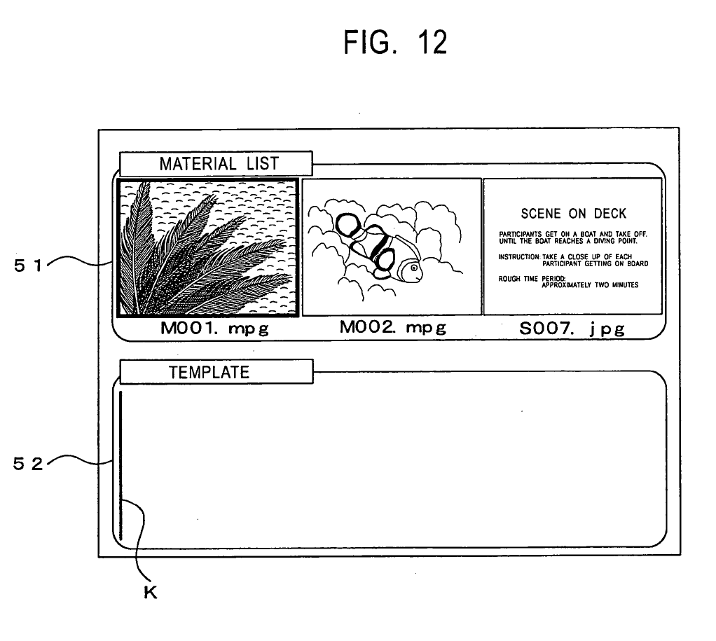

For example, referring to FIG. 12, the user rotates the jog dial 41 to select the clip M001.mpg for the opening image. In this state, the user presses the jog dial 41 (confirms the selected clip). In response to this, a cursor K moves to the template window 52.

In this state, when the user rotates the jog dial 41, the selected scene in the template window 52 (that is, the cursor position) changes. Referring to FIG. 12, since no scene is displayed in the template window 52, the state in FIG. 12 remains unchanged.

The system controller 11 performs the above-described display control in step F101.

While controlling the screen in accordance with the clip selecting operation, the system controller 11 is queued to perform the scene addition-operation in step F102, the menu operation in step F104, or the mode terminating operation in step F105.

When the user presses the jog dial 41 to confirm the selected clip while the cursor K is in the template window 52, the selected clip is allocated to the scene at the position of the cursor K.

This is the scene addition operation. The process proceeds from step F102 to step F103. The system controller 11 copies the selected clip to the cursor position in the template window 52.

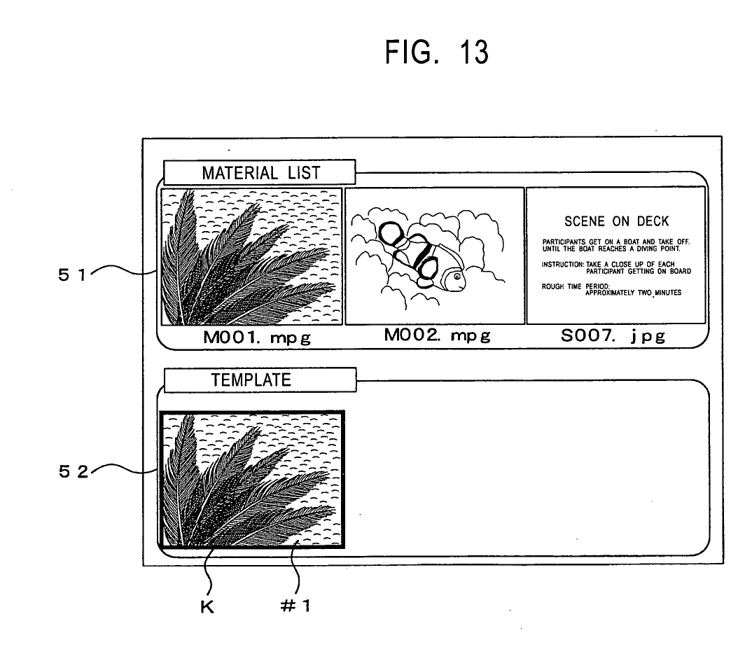

Specifically, the system controller 11 generates template data in which the selected clip is allocated to the scene number at the cursor position in the template window 52 and, as shown in FIG. 13, pastes the selected clip as one scene in the template window 52 in the lower portion of the screen. In this case, the clip M001.mpg is pasted as scene #1 in the template. At this time, the system controller 11 generates template data (scene setup information) in which the clip M001.mpg is allocated to scene #1 in the template.

Similarly, the user repeatedly selects a clip from the material list 51 and pastes the selected clip in the template window 52. Every time the operation is performed, the system controller 11 in step F103 adds the selected clip to the template window 52 and accumulates template data (scene setup information based on the file name of the clip associated with each scene).

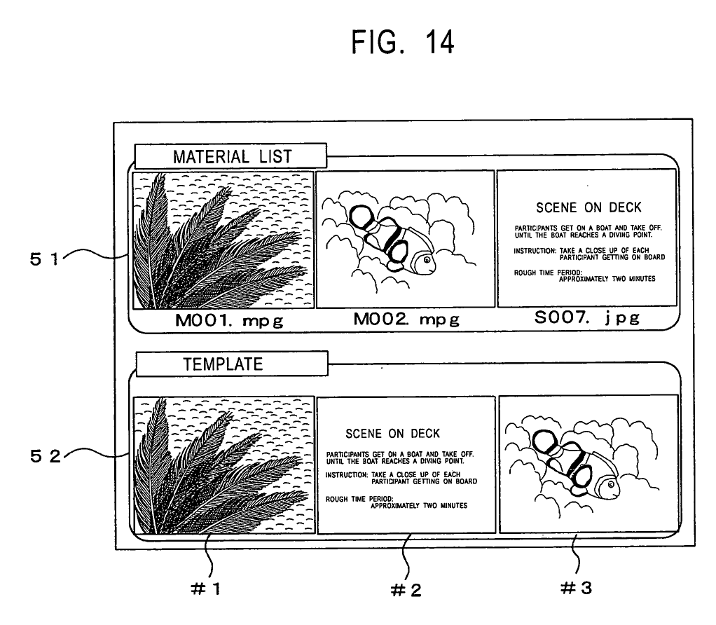

Accordingly, as shown in FIG. 14, clips are arranged in the sequence of scenes (#1, #2, #3, . . . ) in the template window 52.

For example, in the case of FIG. 14, the still image clip S007.jpg shown in FIG. 7 is allocated to scene #2, and the moving image clip M002.jpg is allocated to scene #3.

In the template window 52 in the lower portion of the screen, while the cursor K is in the template window 52, the jog dial 41 is operated to scroll the selected scene.

Basically, the task the user must perform to create a template consists of selecting clips for necessary scenes (the number of clips corresponds to the number of necessary scenes) and pasting the selected clips to the template.

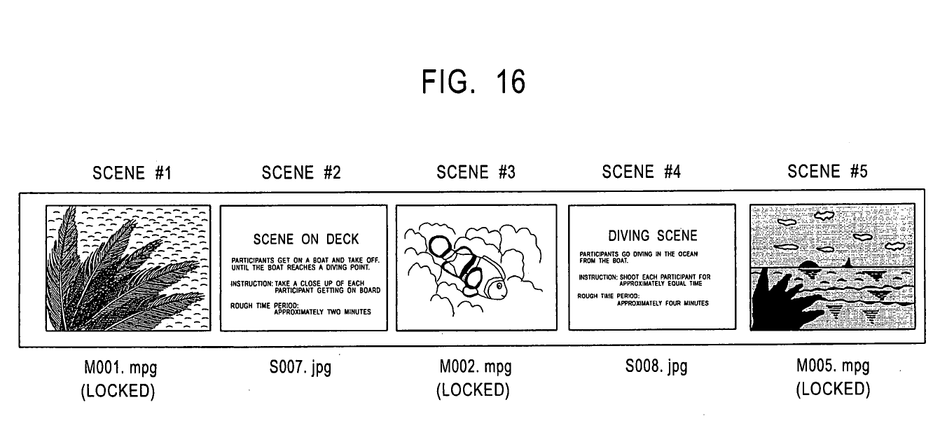

Specifically, to create content shown in FIG. 4, the user completes the content shown in FIG. 16 by selecting, confirming, and pasting clips associated with five scenes, respectively, in the template window 52 in the lower portion of the screen.

The completed content includes, for example, clips that can be used unchanged in the completed content and clips to be replaced after the shooting, which are arranged in the sequence of scenes.

Taking into consideration the degree of freedom in the creation task and the usability of the template at the time of shooting, the scenes can be rearranged and locked.

For example, the user operates the cursor in the template window 52 in the lower portion of the screen to select the scene and presses the menu key 42, thereby performing various operations on the selected scene.

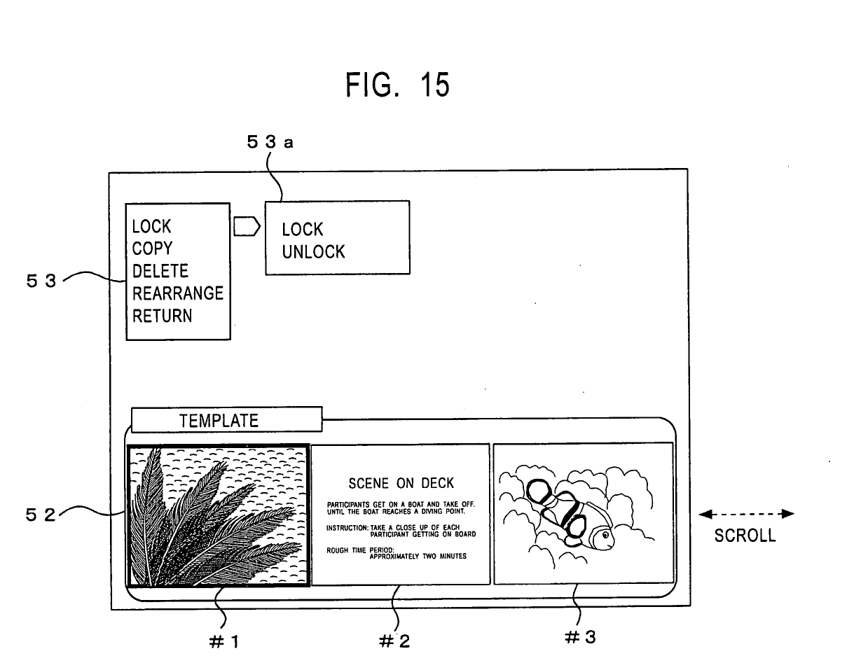

When the menu key 42 is operated while the scene is selected, the system controller 11 proceeds from step F104 to step F106 and displays a menu 53 on the screen, as shown in FIG. 15.

The user selects an item to execute a particular function from the menu 53 and performs the function. In the example of FIG. 15, the menu 53 includes functions to lock, copy, delete, and rearrange the selected scene.

To create the template, the user selects and confirms the clips associated with the scenes in sequence by performing the scene addition operation. When the user selects and confirms the clips in an incorrect sequence or when the user wants to rearrange the clips in a new sequence of the scenes, the user selects the “rearrange” item from the menu 53.

When the “rearrange” item is selected, the system controller 11 proceeds from F106 to step F107. In this case, while a particular scene remains selected, the system controller 11 moves the cursor in accordance with the jog dial 41 operated by the user. In other words, the cursor indicates the destination of the selected scene in the template window 52. When the user moves the cursor to a particular position in the template window 52 and confirms this position, the system controller 11 moves the selected scene to the cursor position. Specifically, the system controller 11 updates the sequence of the scenes in the template data and changes the position of the corresponding clip on the screen.

Alternatively, the “lock” item may be selected from the menu 53 and performed. The locking prohibits the replacement of a clip in the template. By replacement, which will be described in detail later, a clip allocated in the template is replaced with a video image (clip) captured on location. For example, the template shown in FIG. 16 has scenes #2 and #4 which are prescribed to be replaced with actual images captured by the shooting.

In contrast, scenes #1, #3, and #5 are prescribed such that clips allocated to these scenes in the template are used unchanged as scenes in the completed content. In this case, when these scenes are mistakenly replaced with other clips at the time of shooting, a problem occurs. To prevent such a problem, the scenes can be locked individually.

Scene #1 will be used as an example. Since the user plans to use the clip M001.mpg allocated to scene #1 without making any change to it, the user selects scene #1 in the template window 52 and presses the menu key 42 to display the menu 53 shown in FIG. 15. The user selects the “lock” item from the menu 53. As shown in FIG. 15, a sub-menu 53a is displayed, and the user selects “lock” from the sub-menu 53a. Accordingly, scene #1 is locked.

When the “lock” item is selected from the menu 53 and when the “lock” item is selected from the sub-menu 53a, in step F109, the system controller 11 locks the selected scene. Specifically, the system controller 11 turns ON information, such as flag data, indicating whether scene #1 is locked in the template data.

When the “copy” item or the “delete” item is selected from the menu 53, similarly the selected scene is copied or deleted.

When the “copy” item is selected, the system controller 11 proceeds from step F106 to step F110 and makes a copy of the selected scene. In other words, the system controller 11 adds one scene having the same clip to the template window 52 and to the template data being created.

When the “delete” item is selected, the system controller 11 proceeds from step F106 to step F111 and deletes the selected scene. In other words, the system controller 11 deletes one scene from the template window 52 and the template data being created.

After the processing (F107, F109, F110, or F111) from the menu 53 is completed, the system controller 11 returns to step F101.

When the “return” item is selected from the menu 53, in step F108, the system controller 11 stops displaying the menu 53 and returns to step F101.

In this embodiment, four examples of operations/processes from the menu 53 are described. Instead of displaying these operations/processes in the menu format, dedicated operation keys or specific operation steps may be provided.

Besides these processes, other useful processes may be performed in, for example, a menu-driven manner. For example, a process of replacing a clip allocated to a particular scene with another clip may be useful when creating the template.

When the user looks at the template window 52 and determines that the template is created, the user performs a mode terminating operation. For example, the user may select an item to terminate the mode from the menu 53 or may perform a specific operation to terminate the mode.

When the mode terminating operation is performed, the system controller 11 proceeds from step F105 to step F112 and records the currently held template data as a template file on the disk 90.

When the template shown in FIG. 16 is created, the system controller 11 holds the template data with file names associated with scenes #1 to #5. When scenes #1, #3, and #5 are locked, lock flags of scenes #1, #3, and #5 are turned ON.

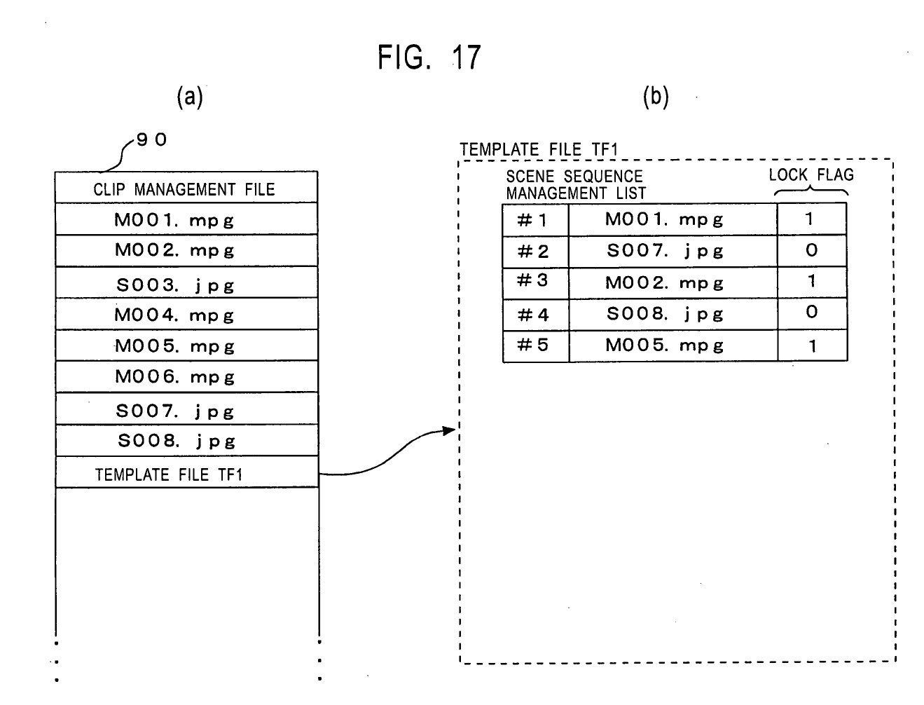

Such template data is recorded as template file TF1 on the disk 90, as shown in FIG. 17(a).

FIG. 17(b) shows the details of template file TF1. In this case, as shown in FIG. 17(b), a scene sequence management list includes specific file names and lock flags associated with the individual scene numbers. Scenes #1, #3, and #5 have files which are moving image clips, whereas scenes #2 and #4 have files which are still image clips showing shooting instruction information.

In step F112, the system controller 11 records the template file. In step F113, the system controller 11 turns off the template creating mode screen and exits from the template creating mode.

As a result, one template is created. Using this template, as described below, the shooting is performed to complete content.

In particular, the template shown in FIG. 16, which is designed to produce content shown in FIG. 4, only requires the shooting of scenes #2 and #4 of the participants on location.

Once the template is created (template file TF1), different pieces of content can be produced by shooting scenes #2 and #4 of different groups of participants using this template. It is unnecessary to create a different template for each piece of content.

By recording at least one template file TF1 on the disk 90, the template-navigated shooting (content production), which will be described below, can be performed. Alternatively, a plurality of templates may be created, and one template may be selected from among the plurality of templates at the time of shooting.

In the template creating mode, an existing template, which has already been recorded as a template file, may be edited.

Specifically, an existing template may be selected in the template creating mode. With the process shown in FIG. 9, a scene may be added, or the details of the template may be changed by the menu operation. The template whose details have been changed in this manner may be used to update the existing template file or may be recorded as a new template file.

In this embodiment, the template file is recorded on the disk 90. Alternatively, for example, the template file may be recorded not on the disk 90, but on another recording medium, such as the flash memory 24.

In this embodiment, the template is created by the video camera 1. Alternatively, a template file may be generated on another information processing apparatus, such as a personal computer, by activating an application that performs the process shown in FIG. 9 on the information processing apparatus.

In this case, the information processing apparatus records the created template file and necessary clips on the disk 90 for use in the video camera 1, and the video camera 1 uses the disk 90 in the subsequent shooting. Alternatively, the information processing apparatus transfers the created template file and necessary clips to the video camera 1, and the video camera 1 records the template file and the clips on the disk 90 (flash memory 24 or the like).

4. Shooting Mode

The operation in the shooting mode will now be described in which the template created in the above manner is used to perform the shooting to produce the content shown in FIG. 4.

By placing the disk 90 having files recorded thereon, as shown in FIG. 17, on the video camera 1, the video camera 1 enters the shooting mode using template file TF1.

The video shooter or the user using the video camera 1 presses, for example, the navigation key 43, and, as a result, the video camera 1 enters the template-navigated shooting mode.

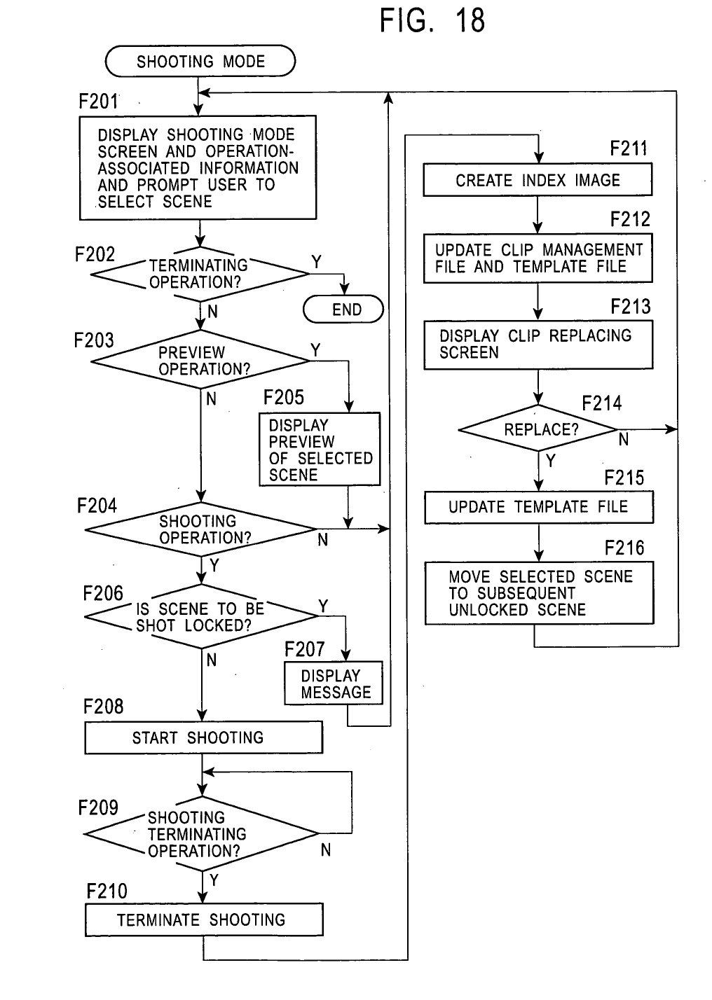

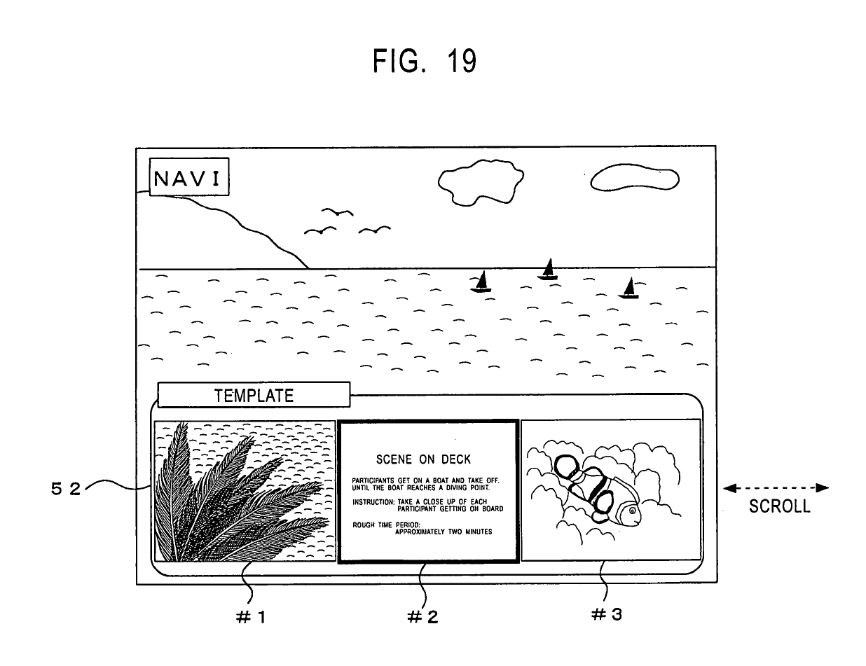

FIG. 18 shows a process performed by the system controller 11 in the shooting mode. FIGS. 19 to 21, 23, 24, and 26 show examples of images displayed on the screen of the LCD 29 (or the viewfinder 31). With reference to these figures, the operation in the shooting mode will now be described.

In the shooting mode, in step F201 of FIG. 18, the system controller 11 displays a shooting mode screen on the LCD 29. The system controller 11 also performs display control in response to a user operation on the shooting mode screen.

The shooting mode screen is, for example, shown in FIG. 19. In this case, a landscape captured by the camera unit 12 at that time, that is, a landscape surrounding an object being shot in the shooting standby mode, is displayed on the screen. For example, the template window 52 is displayed in the lower portion of the screen.

In the template window 52, the scenes in the template shown in FIG. 16 are displayed by index images of the files shown in template file TF1. Referring to FIG. 19, only three index images are displayed. The system controller 11 scrolls these images of the scenes in the template from side to side in accordance with a user operation so that the user can view the images of all scenes.

When a plurality of template files is recorded on the disk 90, the system controller 11 may prompt the user to select a template file to use in the shooting mode.

The user views the template window 52 and selects a scene to shoot.

Specifically, the user rotates the jog dial 41 to highlight the individual scenes in the template window 52. These scenes are highlighted one at a time while being scrolled in accordance with a user operation. FIG. 19 shows a state in which the still image file S007.jpg serving as scene #2 is highlighted.

Viewing the scenes in the template, the user can determine which scene to shoot. In other words, the user can determine that a scene to shoot is a scene with a still image showing a shooting guide.

While a scene is being selected in the template window 52, the user performs the shooting. As a result, an image shot (clip recorded on the disk 90 as a result of the shooting) is managed as a file associated with the selected scene.

In other words, the user views the template window 52, detects a necessary scene to shoot, selects this scene, and performs the actual shooting.

In step F201, the system controller 11 displays the template window 52 on an object being shot and performs display control to display the selected scene in accordance with a user operation.

When a particular scene is selected in the template window 52, a preview of the selected scene can be displayed in response to a user operation.

For example, when the user wants to shoot scene #2 having a clip showing a still image of guide text, the user looks at a preview of the image of scene #2 and perceives a shooting instruction and time.

In this case, as shown in FIG. 19, while scene #2 is selected, the user performs a preview operation. For example, the user presses the play/pause key 44.

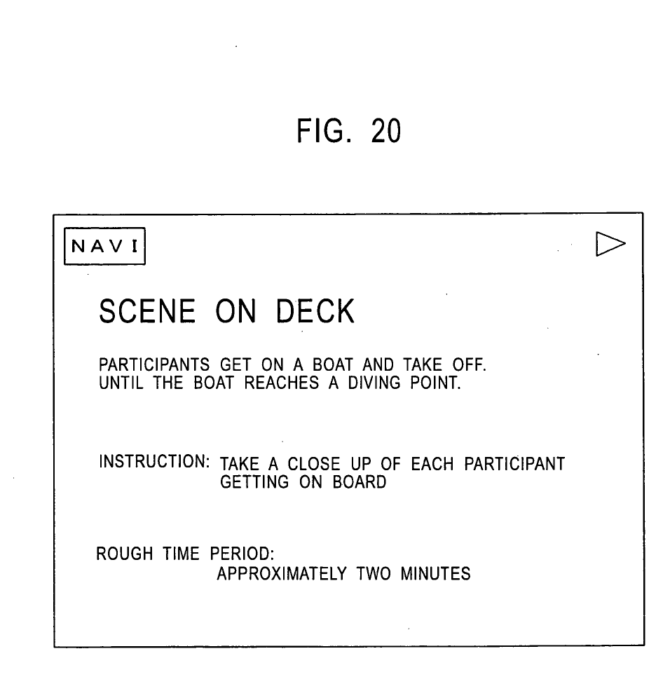

In this case, in step F201, the system controller 11 selects scene #2. In step F203, the system controller 11 detects the preview operation. In step F205, the system controller 11 displays a preview of the selected scene. In this case, as shown in FIG. 17(b), since the clip S007.jpg is allocated to scene #2, the system controller 11 instructs the read/write unit 16 to read the file S007.jpg. Accordingly, as shown in FIG. 20, the LCD 29 displays an image of the read file S007.jpg.

In the case of such a still image file, after displaying in step F205 an image such as that shown in FIG. 20 for a predetermined period of time, the system controller 11 automatically stops displaying the image and returns to step F201. When the user presses, for example, the stop key 45 to terminate the preview, the system controller 11 terminates the preview even if the predetermined period of time has not elapsed.

A preview of a scene, such as scene #1, to which a moving image file has been allocated can be performed. Even when a scene requires no shooting on location, it is advantageous for the user to preview such a scene to understand the flow of scenes of content.

When the user selects, for example, scene #1 and performs a preview operation, in step F205, the system controller 11 similarly causes the read/write unit 16 to play the image of scene #1, that is, the moving image file or the clip M001.mpg, on the LCD 29. In the case of a moving image file, a preview ends when the playing of the moving image is completed (or when the user performs an operation to terminate the preview). The process returns to step F201.

The actual shooting starts in response to an operation by the user to start the shooting while a particular scene is selected in the template window 52.

When the system controller 11 detects in step F204 that an operation is performed to start shooting the selected scene (for example, the record key 48 is operated or the jog dial 41 is pressed while a particular scene is selected), the system controller 11 starts shooting the selected scene.

At the start of the shooting (recording), in step F206, it is determined whether the selected scene is locked.

As described above, in the template, scenes not to be replaced with clips generated by the shooting are individually locked in the template to protect the template settings or to prevent the user from shooting unnecessary scenes.

In the template of FIG. 16 (template file TF1 of FIG. 17), scenes #1, #3, and #5 are locked.

When the user selects scene #1 and mistakenly performs an operation to start shooting scene #1, which requires no shooting, in step F206, the system controller 11 determines that the selected scene is locked. In step F207, the system controller 11 displays a message, such as “the selected scene is locked” or “the selected scene requires no shooting”, on the LCD 29. The system controller 11 does not start the shooting and returns to step F201.

Accordingly, the incorrect or unnecessary shooting of a scene that requires no shooting is prevented.

In contrast, when the user selects scene #2 and performs an operation to start shooting scene #2, in step F206, the system controller 11 determines that scene #2 is an unlocked scene. In step F208, the system controller 11 performs control to start the shooting (recording onto the disk 90).

Specifically, the system controller 11 records video image data captured by the camera unit 12 (and audio data captured by the microphone 33) onto the disk 90.

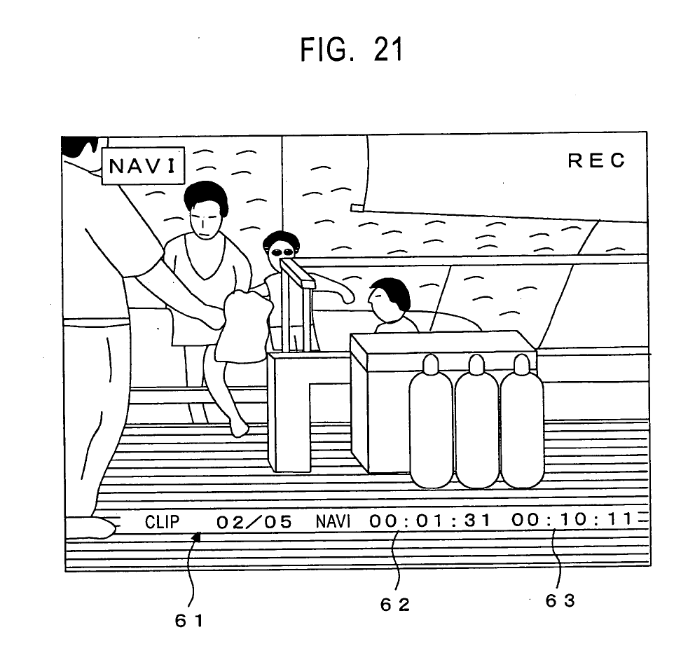

Under the control of the system controller 11, the LCD 29 displays a video image being shot, as shown in FIG. 21.

On the screen of FIG. 21, the system controller 11 displays a number 61 and time codes 62 and 63 of the scene being shot. For example, in the case of FIG. 21, the number 61 indicates “clip 02/05” showing that the clip for the selected scene #2 is being shot.

The time code 62 indicates “navi 00:01:31” showing the running time since the start of the shooting of the clip (hour/minute/second).

The time code 63 indicates “00:10:11” showing the total running time of the content being generated using the template (hour/minute/second). In this case, since moving images are allocated to scenes #1, #3, and #5 on the template, the current total running time of the content, which is obtained by adding the running time of scenes #1, #3, and #5 and the shooting time of scene #2 being currently shot, is displayed. The running time of each scene can be obtained from, for example, information in the clip management file on the disk 90. For example, the running time of scene #1 may be calculated by the data length of the file M001.mpg under management of the clip management file. Alternatively, the playing time itself may be managed.

The shooting continues from the shooting starting operation to the shooting ending operation by the user. The user shoots a necessary shot(s) for an appropriate time based on a rough time period detected on the preview image. When terminating the shooting, the user performs an operation to terminate the shooting, such as re-operating the record key 48 or the stop key 45.

When the system controller 11 detects the shooting terminating operation, the system controller 11 proceeds from step F209 to step S210 and terminates the recording operation by the read/write unit 16. Thus, the shooting is terminated.

In step F211, the system controller 11 causes the read/write unit 16 to create an index image of the clip just shot. In step F212, the system controller 11 updates the clip management file and the template file on the disk 90 in accordance with this shooting.

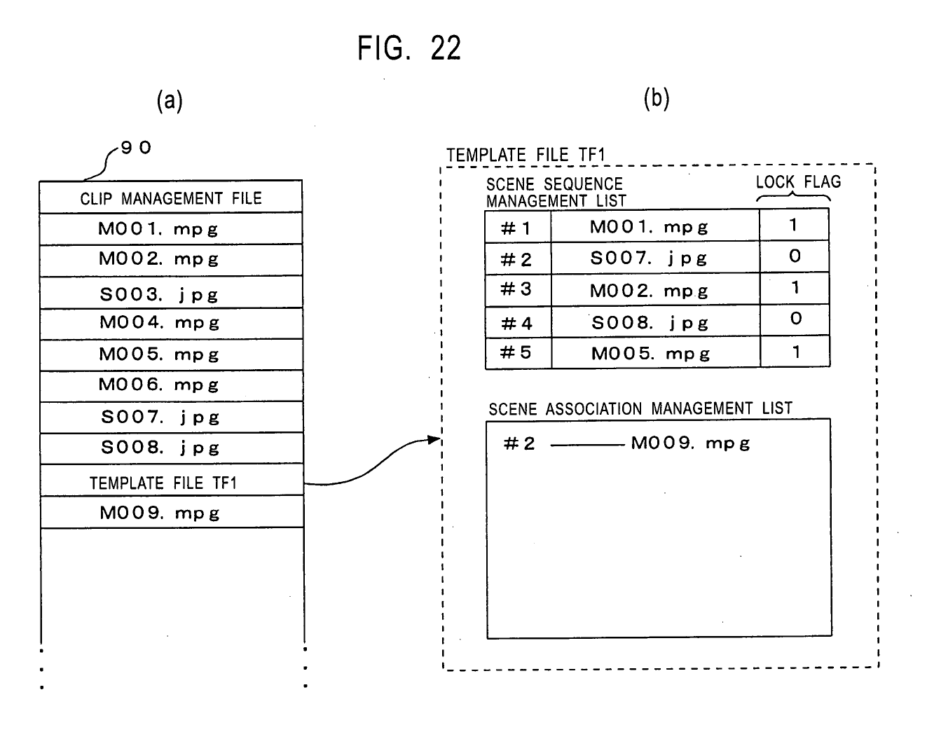

Specifically, as shown in FIG. 22(a), the details of the clip management file are updated so that the clip containing the video data just captured may be managed as one moving image file M009.mpg.

When this shooting is done while scene #2 of template file TF1 is selected, as shown in FIG. 22(b), a scene association management list is generated/updated in template file TF1 so that the clip M009.mpg that has just been shot may be associated with scene #2.

In step F213, the LCD 29 displays a clip replacing screen in response to the termination of the shooting.

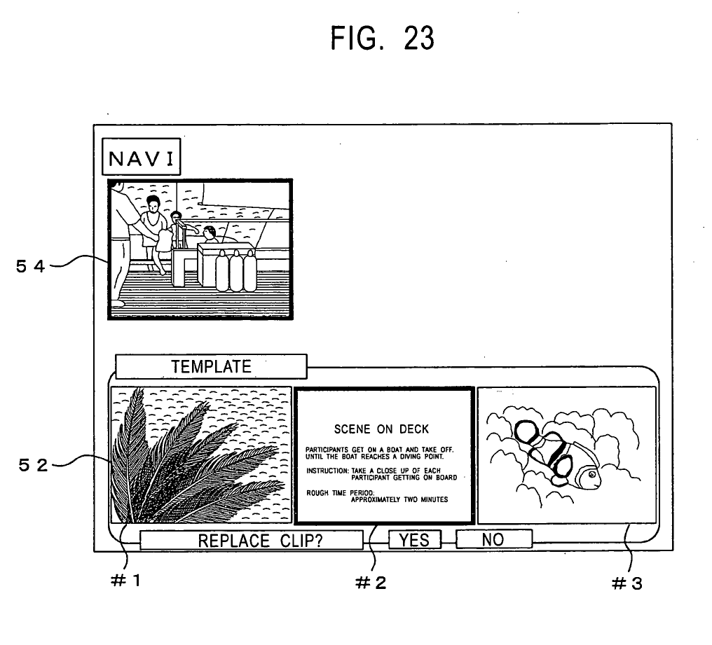

For example, as shown in FIG. 23, an index image of the clip just shot is displayed in a captured clip window 54. A message is displayed asking the user whether to replace the clip S007.jpg allocated to the selected scene #2 with the clip M009.mpg that has just been shot.

Replacing the scene in the template with the clip that has just been shot corresponds to allocating the actual image shot to the template in the course of completion of the content, that is, editing the template.

The user may perform a clip replacement operation immediately after the shooting or may postpone the replacement of the clip.

To replace the clip, the user selects “yes” on the screen shown in FIG. 23 by rotating and pressing the jog dial 41. In response, the process by the system controller 11 proceeds from step F214 to step F215. The system controller 11 instructs the read/write unit 16 to update template file TF1 so that the clip will be replaced.

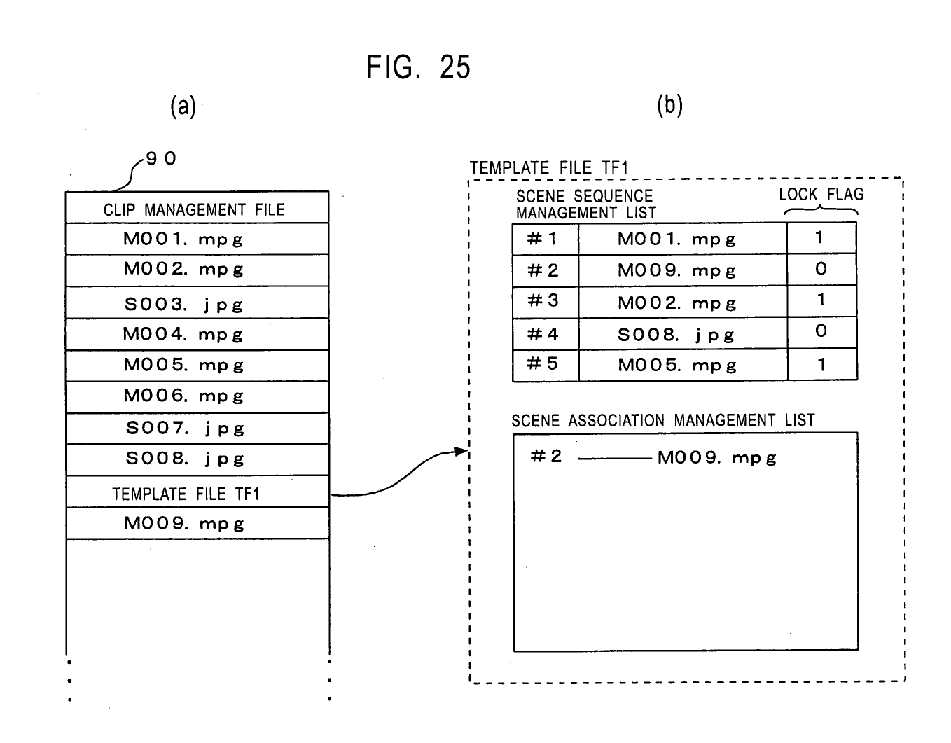

In this case, template file TF1 is updated from the state shown in FIG. 22 to the state shown in FIG. 25. Specifically, in the state shown in FIG. 22, the clip S007.jpg associated with scene #2 is set in the sequence management list of template file TF1. This is updated to the clip M009.mpg, as shown in FIG. 25. Accordingly, the clip M009.mpg that has been shot is fitted as scene #2 in template file TF1.

Along with replacing the clip on the screen, the system controller 11 in step F216 changes the selected scene to the subsequent unlocked scene and returns to step F201.

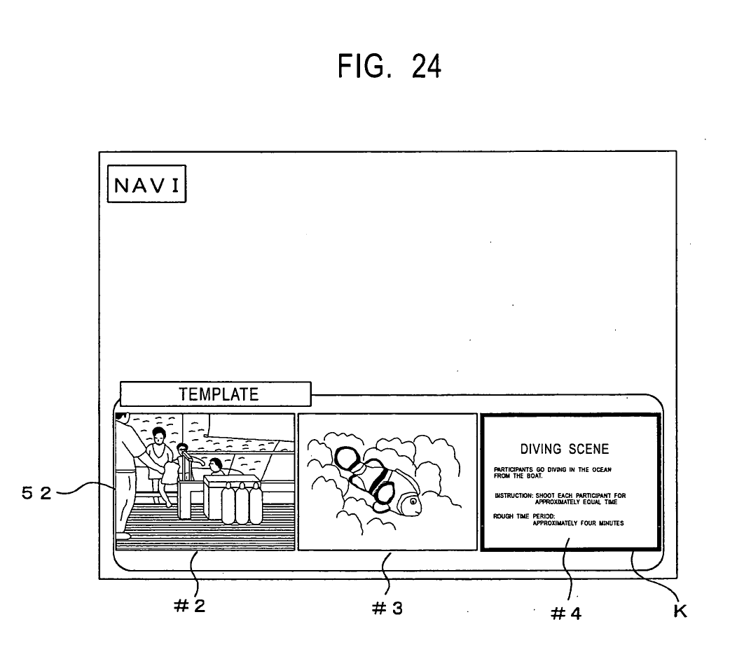

For example, as shown in FIG. 24, the system controller 11 changes scene #2 in the template window 52 to the index image of the clip M009.mpg that has just been shot. Since the subsequent unlocked scene is scene #4, the system controller 11 scrolls the template window 52 and changes the selected scene to scene #4.

When the system controller 11 returns to step F201, scene #4 that needs to be shot is already selected. Therefore, the user may shoot scene #4 in response to a shooting starting operation without performing a selecting operation.

When the user wants to shoot a scene differing from scene #4 that has been automatically selected, the user may perform a scene selecting operation.

Even when the clip has been replaced, the replaced clip (clip S007.jpg in the above case) is not deleted from the disk 90. It is thus possible to replace the new clip with the replaced clip.

In the shooting mode as described above, the clip generated by the shooting may be substituted for the corresponding clip immediately after the shooting. Clip replacement may be performed in a freer manner in the scene re-selecting mode or in the clip random selecting mode, which will be described below.

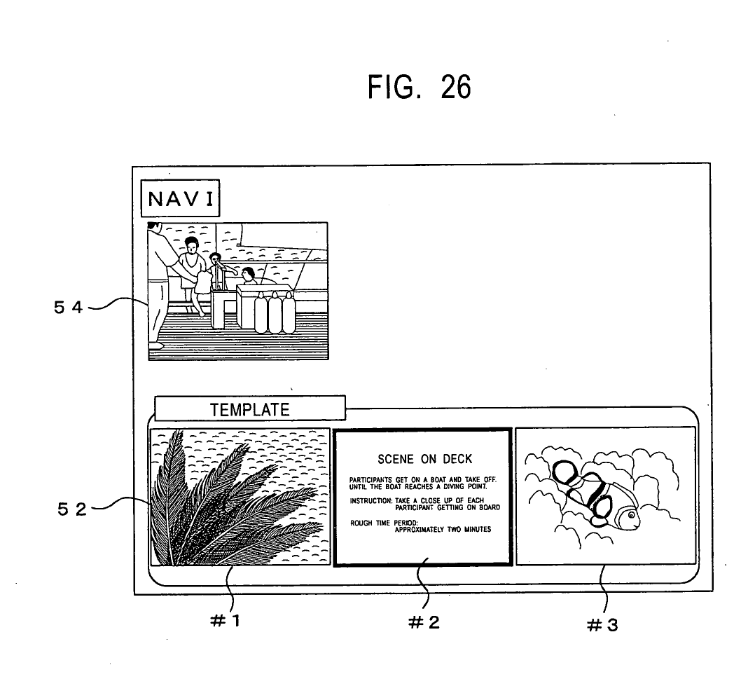

When the user selects “no” on the screen shown in FIG. 23 in order not to replace the clip, the process by the system controller 11 returns from step F214 to step F201. In this case, as shown in FIG. 26, the selected scene on the screen remains unchanged, and only the replacement query text disappears.

Since scene #2 is selected, the captured clip window 54 displays, as shown in FIG. 22, the index image of the clip M009.mpg associated with scene #2.

When the system controller 11 returns to step F201, scene #2 is shot again in response to a shooting starting operation by the user. In other words, this is convenient when taking another take of scene #2.

When the user wants to shoot another scene instead of taking another take of the same scene, the user may perform a normal scene selecting operation.

After the necessary shooting is completed, the user may perform a shooting mode terminating operation. In response, the system controller 11 in step F202 exits from the shooting mode.

With the process shown in FIG. 18, the user selects an arbitrary scene and shoots a clip associated with the selected scene. The user may also shoot a plurality of clips, that is, take 1, take 2, . . . , of one scene.

The clip generated by the shooting may be allocated to the template immediately after being shot or may subsequently replace the corresponding clip in the template. This is selectable in accordance with the circumstances.

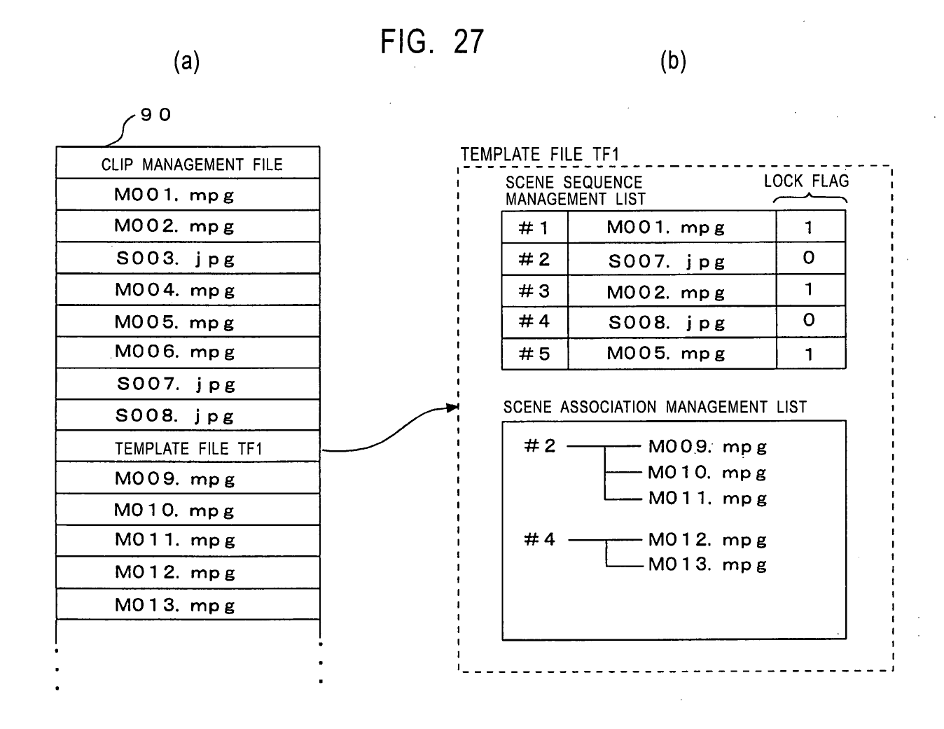

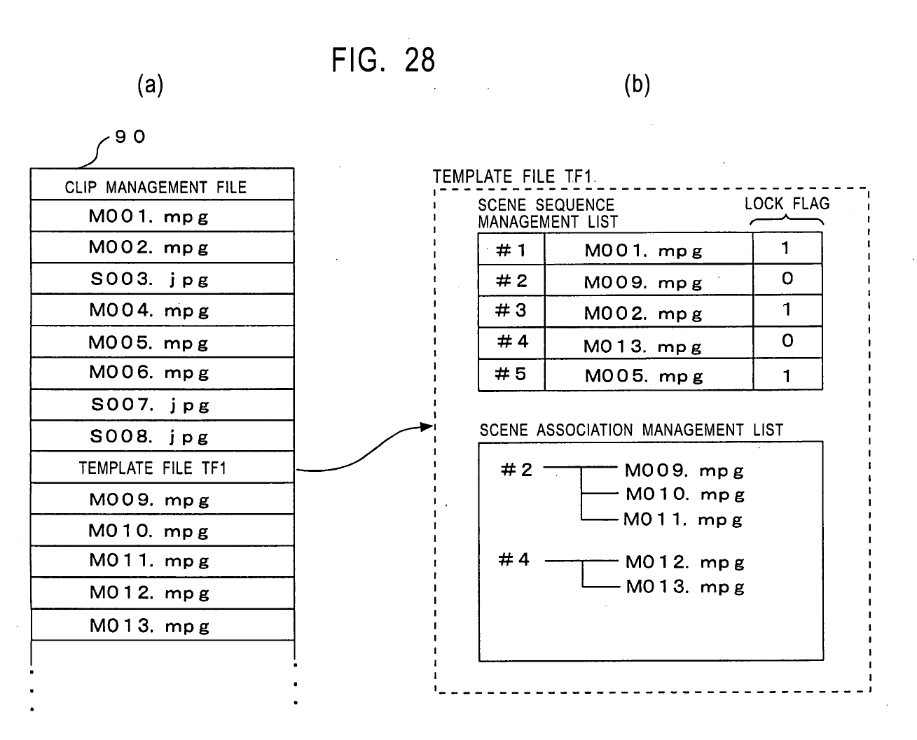

When the user selects scene #2 and shoots three takes of scene #2 and then selects scene #4 and shoots two takes of scene #4, FIG. 27 shows a case in which no clip replacement is performed, and FIG. 28 shows a case in which the clips are replaced.

FIG. 27(a) and FIG. 28(a) each show a state in which five new files M009.mpg, M010.mpg, M011.mpg, M012.mpg, and M013.mpg are recorded on the disk 90 as a result of shooting five takes.

In the case of FIG. 27, no clip replacement is performed. In template file TF1, as shown in FIG. 27(b), files associated with scenes #2 and #4 in the sequence management list remain unchanged since the time of creation of the template, that is, remain unchanged as the clips S007.jpg and S008.jpg.

In the scene association management list, the files M009.mpg, M010.mpg, and M011.mpg serving as takes 1, 2, and 3 are associated with scene #2, and the files M012.mpg and Mp13.mpg serving as takes 1 and 2 are associated with scene #4.

When the shooting mode ends in this state, the clips must be replaced to complete the content. The clip replacement is performed in the scene re-selecting mode or the clip random selecting mode, which will be described below.

In contrast, FIG. 28 shows a case in which the clips are replaced in the shooting mode. In the sequence management list of template file TF1 shown in FIG. 28(b), the file associated with scene #2 is replaced with the clip M009.mpg, and the file associated with scene #4 is replaced with the clip M013.mpg. The scene association management list is the same as that shown in FIG. 27.

When the shooting mode ends in this state, the content can be completed at this time. In other words, when the content is played in accordance with file designations in the scene sequence management list, the completed content is played.

To replace a clip with another clip (for example, to replace the clip M009.mpg associated with scene #2 with the clip M010.mpg), the user can replace the clip in the scene re-selecting mode or the clip random selecting mode, which will be described later.

Alternatively, the clips of some of the scenes may be replaced with other clips in the shooting mode, while the clips of the other scenes remain unchanged.

As shown in FIGS. 22, 27, and 28, the clips generated by the shooting are managed in association with the corresponding scenes under the scene association management list.

The clips managed in this manner are displayed by index images on the screen on which the scene is selected in step F201. For example, referring to FIG. 26, when scene #2 is selected in step F201 in a state shown in FIG. 22 in which the clip M009.mpg generated by the shooting is associated with scene #2, an index image of the clip M009.mpg is displayed in the captured clip window 54.

Referring to FIG. 27, when scene #2 is selected in the template window 52 after the files M009.mpg, M010.mpg, and M011.mpg are associated with scene #2, index images of the clips M009.mpg, M010.mpg, and M011.mpg are displayed.

Accordingly, the user can view in the shooting mode the clips shot in association with the corresponding scenes.

As described above, in step F205 of FIG. 18, the preview of the scene selected in the template window 52 is displayed. Alternatively, a preview of a clip generated by the shooting may be displayed by selecting the clip displayed in the captured clip window 54 and performing a preview operation. In other words, when the system controller 11 detects a preview operation in step F203 while a particular clip in the captured clip window 54 is selected, in step F205, the system controller 11 instructs the read/write unit 16 to play the file of the selected clip. Accordingly, the user can view the details of the captured clip after the shooting.

5. Scene Re-Selecting Mode

For example, when the video camera 1 enters the scene re-selecting mode by pressing, by the user, the navigation key 43 or performing, by the user, a menu operation by operating the menu key 42, a clip of each scene may be selected, that is, the above-described clip replacement may be performed.

When the shooting mode ends in the state shown in FIG. 27, the content will not be completed unless the clips of scenes #2 and #4 are replaced. When the shooting mode ends in the state shown in FIG. 28, the user may want to replace the clip(s).

To this ends, the scene re-selecting mode is provided.

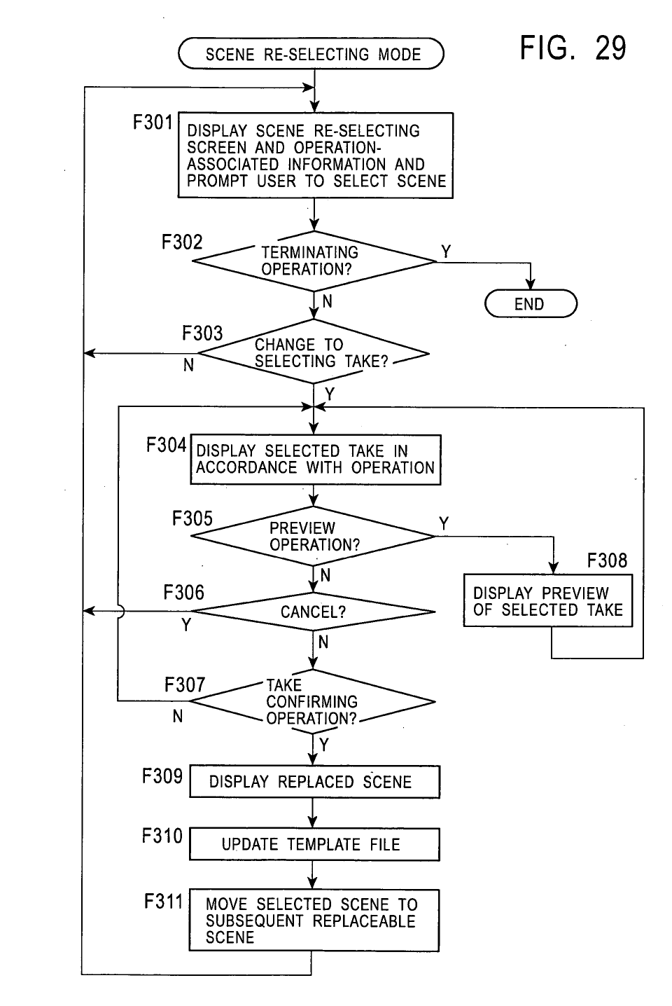

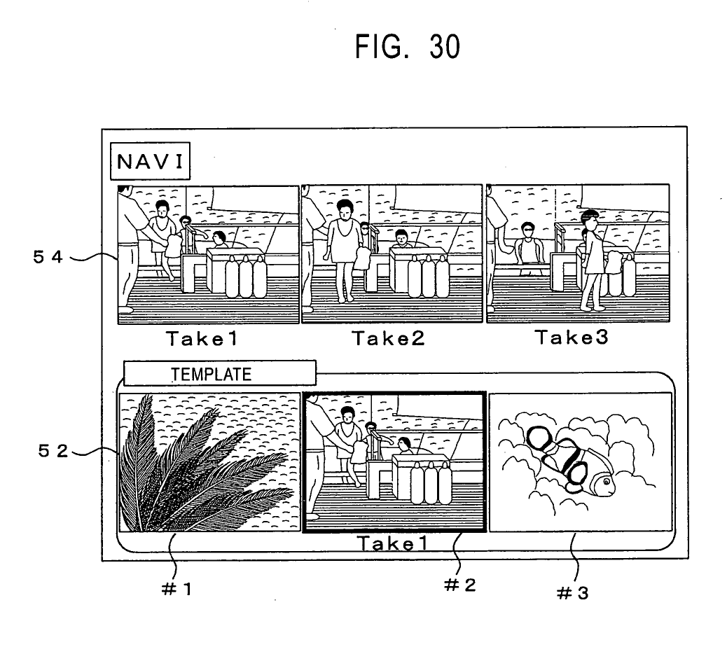

FIG. 29 shows a process by the system controller 11 in the scene re-selecting mode. FIGS. 30, 31, and 32 show examples of images displayed on the LCD 29 (or the viewfinder 31).

When a scene re-selecting mode operation is performed, in step F301 of FIG. 29, the system controller 11 displays a scene re-selecting mode screen on the LCD 29. The system controller 11 also performs display control in response to a user operation on the scene re-selecting mode screen.

The scene re-selecting mode screen is, for example, shown in FIG. 30. In this case, the template window 52 in the lower portion of the screen displays the current scenes of the template with the scene arrangement set in the scene sequence management list in template file TF1. In the template window 52, one scene whose clip can be replaced (scene #2 in this example) is automatically selected.

In the upper portion of the screen, the captured clip window 54 displays clips associated with the scene selected in the template window 52.

The example of FIG. 30 shows a case associated with template file TF1 of FIG. 28.

Specifically, the clips of scenes #2 and #4 are replaced in the shooting mode. The clip M009.mpg serving as take 1 is set to scene #2. Referring to FIG. 30, the index image of the clip M009.mpg is displayed as scene #2 in the template window 52. The template window 52 displays “Take 1” indicating that the clip that has been shot for the first time is currently set to scene #2.

As shown in the scene association management list of FIG. 28, three takes of scene #2 are shot, and the files M009.mpg, M010.mpg, and M011.mpg are associated with scene #2. Referring to FIG. 30, since scene #2 is selected in the template window 52, the index images of the clips M009.mpg, M010.mpg, and M011.mpg serving as takes 1, 2, and 3 associated with scene #2 are displayed in the captured clip window 54.

When many clips are associated with scene #2, these clips may be displayed by scrolling the captured clip window 54.

In the scene re-selecting mode, clip-replaceable scenes are scenes having a clip(s) associated therewith in the scene association management list. In the state shown in FIG. 28, scenes #2 and #4 are clip-replaceable scenes.

In the scene re-selecting mode, as shown in FIG. 30, one scene (scene #2) whose clip is replaceable is automatically selected in the template window 52. This is convenient for the user in terms of usability.

When the user wants to replace the clip of scene #4 in this state, the user may perform an operation to select scene #4. In this case, although not shown in the drawing, index images of M012.mpg and M013.mpg are displayed in the captured clip window 54.

Alternatively, it is preferable that only the replaceable scenes be selectable by operating the jog dial 41. In this case, the cursor can move only to scenes #2 and #4 by operating the jog dial 41, whereas the cursor cannot move to the other scenes #1, #3, and #5.

Alternatively, instead of automatically selecting a scene in the initial state, a scene may be selected only if the user has operated the jog dial 41.

Referring to FIG. 30, the cursor in the initial state is in the template window 52 in the lower portion of the screen. A particular scene is selected automatically or manually. In step F301, an image in response to the selected scene is displayed.

Specifically, when a particular scene is selected and when the user presses the jog dial 41, the cursor moves to the captured clip window 54 in the upper portion of the screen.

The system controller 11 detects this type of operation as a movement operation to select the take and proceeds from step F303 to step F304. The system controller 11 performs display control to prompt the user to select the take by moving the cursor to the upper portion of the screen.

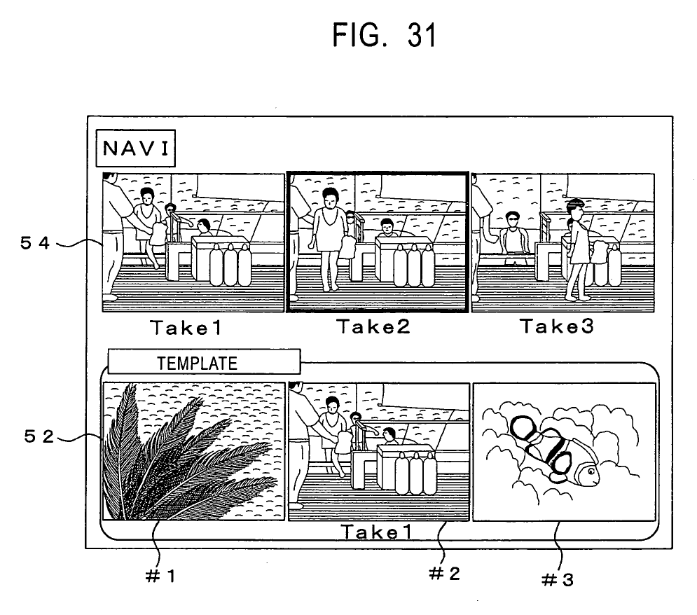

The user may select a desired clip from among clips that have been shot by rotating the jog dial 41. For example, FIG. 31 shows a state in which the clip M010.mpg serving as take 2 is selected. In step F304, the system controller 11 performs display control in accordance with the take selecting operation.

In such a state in which a particular take is selected, a preview of the selected take may be displayed in response to a user operation.

When the user performs a preview operation by operating the play/pause key 44 while the particular take is selected, the system controller 11 proceeds from step F305 to step F308 and displays a preview of the selected take. Referring to FIG. 31, to display a preview of the selected clip M010.mpg serving as take 2, the system controller 11 instructs the read/write unit 16 to play the file M010.mpg. Accordingly, the playback image of the file M010.mpg is displayed on the LCD 29.

In this case, when the selected take is a still image, a preview of the selected take is displayed for a predetermined period of time. When the selected take is a moving image, a preview of the selected take is performed until the playback ends. In either case, when the user performs a preview terminating operation by operating the stop key 45 or the like, the preview is terminated.

When the user performs a cancel operation while the take is selected, that is, while the cursor is in the upper portion of the screen, the process returns from step F306 to step F301. In other words, the cursor returns to the scene selecting screen in the lower portion.

To replace the clip, the user selects a particular take and confirms the selected take, as shown in FIG. 31. Specifically, the user selects a desired take by rotating the jog dial 41, which is displayed in step F304, and presses the jog dial 41 to confirm the selected take.

In response, the system controller 11 proceeds from step F307 to step F309 and displays the replaced scene.

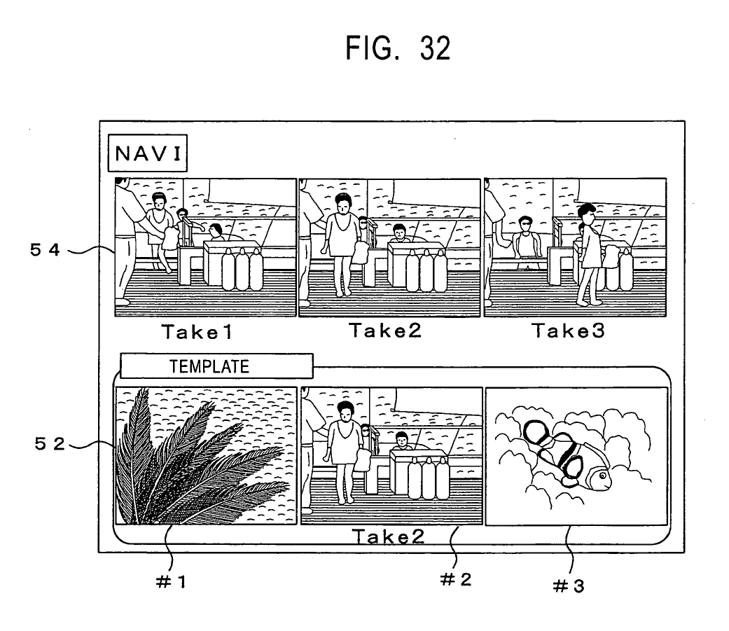

For example, as shown in FIG. 31, after the user selects and confirms scene #2, the system controller 11 in step F309 displays scene #2 replaced with take 2, as shown in FIG. 32.

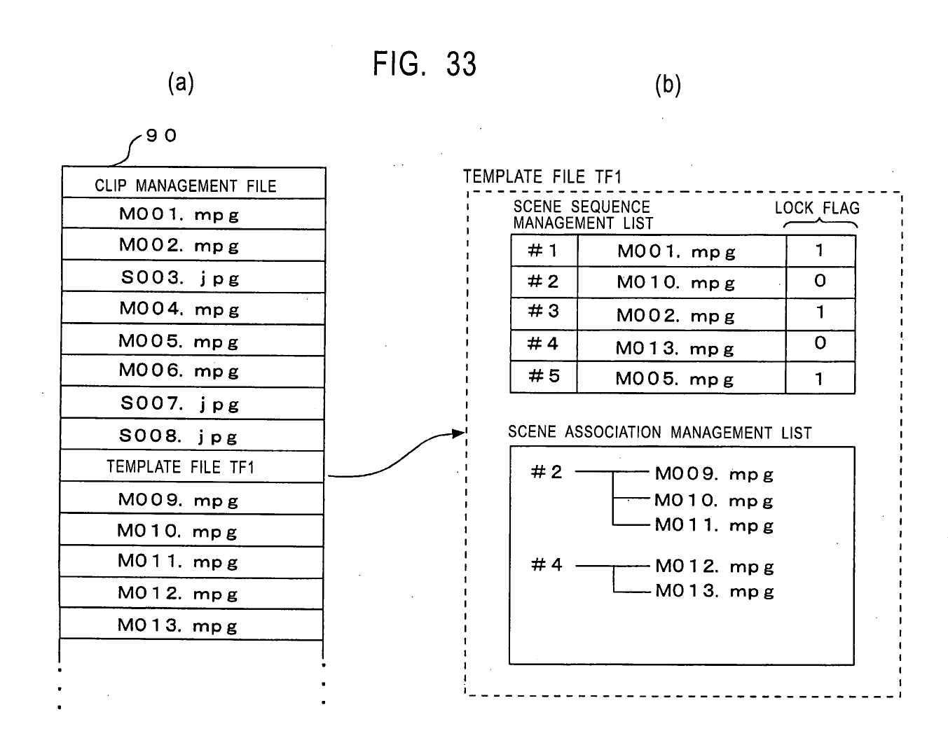

In step F310, the clip is replaced in template file TF1. In other words, the system controller 11 instructs the read/write unit 16 to update template file TF1. Specifically, referring to FIG. 28, the clip associated with scene #2 in the scene sequence management list is rewritten from the clip M009.mpg to the clip M010.mpg, as shown in FIG. 33.

Accordingly, the replacement of the clip is completed. In step F311, the system controller 11 changes the selected scene to the subsequent replaceable scene (scene #4 in this case) and returns to step F301.

When the user wants to replace the clip of scene #4, the clip can be replaced in a similar manner.

When the user performs a mode terminating operation, in step F302, the system controller 11 exists from the scene re-selecting mode.

In the above-described scene re-selecting mode, a clip to be used in the content may be arbitrarily selected from among the captured clips subsequent to the shooting.

In step F308, the preview of the selected take may be displayed. It is also preferable that a preview of the scene selected in step F301 be displayed.

Although a clip-replaceable scene is defined as a scene associated with a captured clip in the scene association management list, a clip-replaceable scene may be limited to a scene associated with a plurality of clips generated by the shooting.

6. Clip Random Selecting Mode

Basically the clip random selecting mode is similar to the scene re-selecting mode. In the clip random selecting mode, a clip associated with a scene can be replaced.

In the scene re-selecting mode, a clip of a scene associated with a captured clip(s) in the scene association management list may be replaced with a clip selected from among the associated captured clip(s). In the clip random selecting mode, a clip of each scene may be replaced with any clip selected from among all clips without limitation.

Specifically, as shown in FIG. 33(a), when various clips, that is, files M001.mpg to M013.mpg, are recorded on the disk 90, the clip of each scene may be replaced with any clip selected from among all clips recorded on the disk 90.

Since the basic process in the clip random selecting mode is similar to that of FIG. 29, a repeated description thereof is omitted. The process in the clip random selecting mode differs from that in the scene re-selecting mode in that all scenes are selectable in the template window 52 and that all clips recorded on the disk 90 serve as selection candidates for a take to be selected in the captured clip window 54.

Accordingly, a clip to serve as scene #1 may be re-selected and set, or a clip associated with scene #4 may be set to scene #2.

7. Playback of Completed Content

The content is completed by performing the shooting and/or clip replacement in the shooting mode and/or, where necessary, by performing the clip replacement in the scene re-selecting mode or in the clip random selecting mode.

Specifically, the clips associated with the corresponding scenes described in the scene sequence management list in template file TF1 become the scenes of the completed content.

When the user selects template continuous playback from the menu of the video camera 1, the clips allocated to the scenes in template file TF1 are played seamlessly. In other words, the system controller 11 causes the read/write unit 16 to play the clips, which are described in the scene sequence management list, one after another.

The resultant playback images are the images of the completed content.

For example, these images of the content may be output via the external interface 20 to a recording apparatus, and the recording apparatus records the images of the content on a recording medium, such as another disk or a videotape. As a result, the content may be stored or sold.

8. Advantages of the Embodiment

According to the above-described embodiment, the following advantages are achieved:

By sequentially selecting and setting image materials (clips) serving as moving images and/or still images recorded on the disk 90, an imaging template with the flow of a series of scenes is created. Even a user who is not familiar with the planning of content can easily draw a content project by creating a template within a short period of time.

In a template, the user allocates a clip to each scene. The user can easily imagine the completed content. With this regard, the user can draw a content project achieving a certain standard without experience. For example, this is convenient when producing content achieving a business standard.

The present invention is efficient since once a template is created for, for example, a business application, this template can be used many times.

Since a template can be created using the video camera 1 or a personal computer, a large system is unnecessary. When the template is created using the video camera 1, the shooting can be performed without a break.

Since scenes in a template can be rearranged, deleted, and copied, a flexible, efficient template can be created.

Since scenes can be locked, necessary scenes are prevented from being replaced after the shooting.

Clips associated with scenes that need to be shot are easily generated using, for example, still images of pieces of paper or boards on which the corresponding instructions are written. This facilitates the creation of the template.

The shooting can be carried out by simply selecting scenes in accordance with a template. The content can be completed by replacing clips of the scenes in the template with clips generated by the shooting. Even when a user is not an expert with special knowledge and skills, video content can be quickly produced in a simple, efficient manner using simple equipment and materials. The editing that must be performed to complete the content is minimal, only requiring replacement of the clips.

Since the shooting may be done by using a template for completed content as a guide, the user will not fail to shoot necessary scenes and will not shoot unnecessary landscapes or redundant scenes.

For scenes requiring no new shooting, clips allocated to these scenes in a template can be used as they are in completed content. Therefore, the shooting is minimized. This is convenient when many pieces of content are produced by changing only part of each piece of content.

Since a clip generated by the shooting is managed in association with a selected scene, the user is not required to pay attention to control of management of the clip generated by the shooting by the user.

Since a clip generated by the shooting is managed in association with a selected scene, the sequence of shooting does not necessarily bear any resemblance to the sequence of scenes. The shooting schedule thus becomes freer.

Clips serving as a plurality of takes of one scene in a template can be managed. This is convenient when shooting another take or selecting a take from among a plurality of takes.

Since a clip allocated to each scene in a template or a clip (take) generated by the shooting is displayed as an index image, the user can easily detect the details of each scene and the details and circumstances of shooting. The displaying of index images is convenient for selecting a scene.

A preview of a clip allocated to each scene or a preview of a clip (take) generated by the shooting is displayed to enable the user to view the details of the corresponding clip. This is convenient for shooting and replacing a clip.

A clip serving as a scene in a template can be replaced in the shooting mode, the scene re-selecting mode, or the clip random selecting mode depending on the circumstances. The time and the editing details are unrestricted.

Since a template is recorded on the disk 90 on which clips are recorded, a process of creating a template and shooting and completing content is performed using the disk 90.

9. Modifications

Although the embodiment of the present invention has been described above, the present invention is not limited to the above-described embodiment, and various modifications can be made.

The configuration of the video camera 1 is not limited to that shown in FIGS. 1 and 2.

A template may be created not only by the video camera 1, but also by another information processing apparatus including a personal computer or an audio-visual apparatus. In such a case, not only the created template may be transferred to the video camera 1 via the external interface 20, but also the created content may be transferred from a remote place via wireless or wired communication to the video camera 1 having the communication unit 21. Clips set in the template may be communicated in a similar manner.

The video camera 1 records a received template and clips on the disk 90. Accordingly, the video camera 1 can carry out the shooting described in the above-described embodiment.

A recordable/playable disk medium, such as a magneto-optical (MO) disk or a phase change disk, is suitable to be used as the disk 90 in the above-described embodiment. Alternatively, a different-format recording medium, such as an HDD or a memory card using a flash memory or the like, may be used in place of the disk 90. Any non-linear recording medium that has sufficient capacity to record at least video data can be used.

The video camera 1 has the LCD 29 to display various images, as described above. Alternatively, an external monitor may be connected to the video camera 1, and various images may be displayed on this external monitor. In this sense, the LCD 29 need not be provided. Alternatively, various images described above may be displayed only on the viewfinder 31.

In the above example, the video camera 1 records video image data on the disk 90 at the time of shooting. In addition to recording the video image data on the disk 90, the video camera 1 may transmit the video image data to the outside via the communication unit 21.

In such a case, when the receiver has the same template, the receiver can replace a clip with a received clip to produce content whose details differ from those of the content produced by the video camera 1.

In the above-described embodiment, as shown in FIGS. 7 and 8, still image clips are allocated to scenes to be shot in a template, and no control information concerning the corresponding scenes is included in the template.

Alternatively, the template may include some type of control information.

For example, the template may include shooting time setting data in the form of metadata or the like for a clip associated with a particular scene.

At the time of shooting, the system controller 11 reads the shooting time setting data. When the system controller 11 counts time from the start of shooting and when the time indicated by the shooting time setting data is expired, the shooting may be terminated automatically.

Accordingly, the user need not pay special attention to the shooting period and may concentrate on the shooting operation, such as the circumstances of an object being shot, and operations including a zoom and a pan.

In the above-described embodiment, template file TF1 (scene sequence management file) is rewritten in accordance with the replacement of clips. When one template on a disk is used many times, it is necessary to save the details of the original template file in which no clips are replaced.

When the created template file TF1 and clips are copied to many disks 90 and when one disk is used to produce one piece of content, the original template need not be saved on the disk.

To create a template file in the above-described embodiment, the system controller 11 of the video camera 1 or another information processing apparatus may perform a program for executing the process shown in FIG. 9.

To perform the processes in the shooting mode, the scene re-selecting mode, and the clip random selecting mode in the above-described embodiment, the system controller 11 of the video camera 1 may perform a program for executing the processes shown in FIGS. 18 and 29.

With these programs, the template creation, shooting, and clip replacement achieving the above-described advantages can be implemented without using a special dedicated apparatus. Content is produced simply at low cost.

According to a program recording medium having the programs recorded thereon, the programs implementing the template creation, shooting, and clip replacement can be easily provided to the general public. This is also convenient when designing the video camera 1 or upgrading the version of the video camera 1.

The programs implementing the template creation, shooting, and clip replacement may be stored in a recording medium, such as the ROM 22 or the flash memory 24 of the video camera 1, or recorded in advance on an HDD serving as a built-in recording medium in an apparatus, such as a personal computer, a ROM included in a CPU, or the like.

Alternatively, these programs may be stored (recorded) temporarily or permanently in a removable recording medium, such as a flexible disk, CD-ROM (Compact Disc Read Only Memory), MO disk, DVD (Digital Versatile Disc), magnetic disk, or semiconductor memory. Such a removable recording medium can be provided as so-called packaged software.

The programs implementing the template creation, shooting, and clip replacement may be installed from the removable recording medium into the video camera 1, a personal computer, or the like or may be downloaded from a download site via a network, such as a LAN (Local Area Network) or the Internet.

What is claimed is:

1. An imaging apparatus comprising:
imaging means for capturing an image of an object being shot and generating a video image signal;
recording and playing means for recording various information including the video image signal on a recording medium and playing the information recorded on the recording medium;
shooting scene selection control means for performing a process of selecting a particular scene to be shot from an imaging template in which the arrangement of scenes of content is indicated by image materials selected from among moving image materials and/or still image materials recorded on the recording medium;
video image managing means for recording, when the shooting is performed by the imaging means while the particular scene is selected by the process by the shooting scene selection control means, the video image signal generated by the shooting as an image material on the recording medium using the recording and playing means and for managing the image material recorded on the recording medium in association with the selected scene in the imaging template; and
replacement control means for replacing the image material constituting each of the scenes in the imaging template with another image material.

2. An imaging apparatus according to claim 1, wherein the imaging template comprises information recorded on the recording medium.

3. An imaging apparatus according to claim 1, wherein the shooting scene selection control means prompts a user of the imaging apparatus to select the particular scene by displaying index images of the image materials of the scenes in the imaging template.

4. An imaging apparatus according to claim 1, wherein the video image managing means records, on the recording medium, management information for managing each of the image materials recorded on the recording medium in association with the corresponding scene in the imaging template.

5. An imaging apparatus according to claim 1, wherein, when the video image signal generated by the shooting while the particular scene is selected by the shooting scene selection control means is recorded as the image material on the recording medium, the replacement control means replaces the image material of the selected scene in the imaging template with the image material generated by the shooting.

6. An imaging apparatus according to claim 1, wherein the replacement control means replaces the image material of the particular scene in the imaging template with an image material selected from among the image materials managed in association with the particular scene by the video image managing means.

7. An imaging apparatus according to claim 1, wherein the replacement control means replaces the image material of the particular scene in the imaging template with an image material selected from among the image materials recorded on the recording medium.

8. A content producing method comprising:
a first step of selecting a particular scene to be shot from an imaging template in which the arrangement of scenes of content is indicated by image materials selected from among moving image materials and/or still image materials recorded on a recording medium;
a second step of recording, when the shooting is performed while the particular scene is selected in the first step, a video image signal generated by the shooting as an image material on the recording medium and managing the image material recorded on the recording medium in association with the selected scene in the imaging template; and
a third step of replacing the image material constituting each of the scenes in the imaging template with another image material.

9. A content producing method according to claim 8, wherein the imaging template comprises information recorded on the recording medium.

10. A content producing method according to claim 8, wherein, in the first step, a user is prompted to select the particular scene by displaying index images of the image materials of the scenes in the imaging template.

11. A content producing method according to claim 8, wherein, in the second step, management information for managing each of the image materials recorded on the recording medium in association with the corresponding scene in the imaging template is recorded on the recording medium.

12. A content producing method according to claim 8, wherein, in the third step, when the video image signal generated while the particular scene is selected in the first step is recorded as the image material on the recording medium, the image material of the selected scene in the imaging template is replaced with the generated image material.

13. A content producing method according to claim 8, wherein, in the third step, the image material of the particular scene in the imaging template is replaced with an image material selected from among the image materials managed in association with the particular scene in the second step.

14. A content producing method according to claim 8, wherein, in the third step, the image material of the particular scene in the imaging template is replaced with an image material selected from among the image materials recorded on the recording medium.

15. A program for causing a computer to perform a content producing method, the content producing method comprising:
a first step of selecting a particular scene to be shot from an imaging template in which the arrangement of scenes of content is indicated by image materials selected from among moving image materials and/or still image materials recorded on a recording medium;
a second step of recording, when the shooting is performed while the particular scene is selected in the first step, a video image signal generated by the shooting as an image material on the recording medium and managing the recorded image material in association with the selected scene in the imaging template; and
a third step of replacing the image material constituting each of the scenes in the imaging template with another image material.

16. An imaging template creating method comprising:
a setting step of setting an image material selected from among moving image materials and/or still image materials recorded on a recording medium to each of scenes of content to be produced; and
a management step of managing scene setup information as an imaging template, the scene setup information including one or more image materials set to each of the scenes one after another by performing the setting step one or more times.

17. An imaging template creating method according to claim 16, wherein, in the setting step, the scene setup information is recorded as an imaging template file on the recording medium and managed as an imaging template.

18. An imaging template creating method according to claim 16, wherein, in the setting step, index images of the moving image materials and/or the still image materials recorded on the recording medium are displayed.

19. An imaging template creating method according to claim 16, further comprising a changing step of changing the sequence of the scenes set by the scene setup information.

20. An imaging template creating method according to claim 16, further comprising a prohibiting step of prohibiting replacement of the selected moving image material or the selected still image material of the corresponding scene set by the scene setup information.

21. An imaging template creating method according to claim 16, further comprising a deletion step of deleting the scene setting of each of the scenes set by the scene setup information.

22. An imaging template creating method according to claim 16, further comprising a copying step of copying the scene setting of each of the scenes set by the scene setup information.

23. A program for causing a computer to perform an imaging template creating method, the imaging template creating method comprising:
a setting step of setting an image material selected from among moving image materials and/or still image materials recorded on a recording medium to each of scenes of content to be produced; and
a management step of managing scene setup information as an imaging template, the scene setup information including one or more image materials set to each of the scenes one after another by performing the setting step one or more times.

24. An imaging apparatus comprising:
imaging means for capturing an image of an object being shot and generating a video image signal;
recording and playing means for recording various information including the video image signal on a recording medium and playing the information recorded on the recording medium;
scene selection control means for setting an image material selected from among moving image materials and/or still image materials recorded on the recording medium to each of scenes of content to be produced; and
template setup means for managing scene setup information as an imaging template, the scene setup information including one or more image materials set to each of the scenes one after another by the scene selection control means.

25. An imaging apparatus according to claim 24, wherein the template setup means records the scene setup information as an imaging template file on the recording medium using the recording and playing means and manages the scene setup information as an imaging template.

26. An imaging apparatus according to claim 24, wherein the scene selection control means prompts a user of the imaging apparatus to select one image material from among the moving image materials and/or the still image materials recorded on the recording medium by displaying index images of the moving image materials and/or the still image materials.

27. An imaging apparatus according to claim 24, further comprising sequence changing control means for changing the sequence of the scenes set by the scene setup information by the scene selection control means.

28. An imaging apparatus according to claim 24, further comprising locking control means for prohibiting replacement of the selected moving image material or the selected still image material of the corresponding scene set by the scene setup information by the scene selection control means.

29. An imaging apparatus according to claim 24, further comprising scene deletion control means for deleting the scene setting of each of the scenes set by the scene setup information by the scene selection control means.

30. An imaging apparatus according to claim 24, further comprising scene copy control means for copying the scene setting of each of the scenes set by the scene setup information by the scene selection control means.
